(19) United States
(12) Patent Application Publication
(10) Pub. No.: US 2004/0016632 A1
(43) Pub. Date: Jan. 29, 2004

(54) Methods of making transition metal compounds useful as cathode active materials using electromagnetic radiation

(76) Inventor: Jeremy Barker, Shepton-Under-Wychwood (GB)

Correspondence Address: VALENCE TECHNOLOGY, INC., 301 CONESTOGA WAY, HENDERSON, NV, 89015, US

(21) Appl. No.: 10/205,748

(22) Filed: Jul. 26, 2002

(51) Int. Cl. C01G 1/00; B01J 19/08

(52) U.S. Cl. 204/157.4; 423/592.1; 423/311; 423/463; 423/594.2; 422/186

(57) ABSTRACT

In a method for synthesizing reduced metal compounds using electromagnetic radiation, starting materials comprising at least one particulate metal compound and at least one source of carbon are combined to form a mixture. The mixture is exposed to electromagnetic radiation to form a reaction product. Preferably, the carbon is a reducing carbon, and at least one metal of the starting materials is reduced in oxidation state during radiation exposure. Reducing carbon may be supplied by elemental carbon, by an organic material, or by mixtures. Preferably, the solid state reactants also include an alkali metal compound. The products of the method are preferably useful as cathode active materials in lithium ion batteries. The electromagnetic radiation is selected from among microwave, infrared, and radio frequencies of about 1 MHz to 3000 GHz.

### FIELD OF THE INVENTION

This invention relates to methods for producing electrode active materials which can be used to formulate electrodes for use in electrochemical cells in batteries using electromagnetic radiation.

### BACKGROUND OF THE INVENTION

In general, batteries are devices that convert chemical energy into electrical energy, by means of an electrochemical oxidation-reduction reaction. Batteries are used in a wide variety of applications, particularly as a power source for devices that cannot practicably be powered by centralized power generation sources (e.g., by commercial power plants using utility transition lines).

Batteries can generally be described as comprising three components: an anode that contains a material that is oxidized (yields electrons) during discharge of the battery (i.e., while it is providing power); a cathode that contains a material that is reduced (accepts electrons) during discharge of the battery; and an electrolyte that provides for transfer of ions between the cathode and anode. During discharge, the anode is the negative pole of the battery, and the cathode is the positive pole. Batteries can be more specifically characterized by the specific materials that make up each of these three components. Selection of these components can yield batteries having specific voltage and discharge characteristics that can be optimized for particular applications.

Batteries containing lithium and sodium afford many potential benefits, because these metals are light in weight, while possessing high standard potentials. For a variety of reasons, lithium batteries are, in particular, commercially attractive because of their high energy density, higher cell voltages, and long shelf-life.

Lithium batteries are prepared from one or more lithium electrochemical cells containing electrochemically active (electroactive) materials. Among such batteries are those having metallic lithium anodes and metal chalcogenide (oxide) cathodes, typically referred to as “lithium metal” batteries. The electrolyte typically comprises a salt of lithium dissolved in one or more solvents, typically nonaqueous aprotic organic solvents. Other electrolytes are solid electrolytes (typically polymeric matrixes) that contain an ionic conductive medium (typically a lithium containing salt dissolved in organic solvents) in combination with a polymer that itself may be ionically conductive but electrically insulating.

A lithium battery that uses an “insertion anode” rather than lithium metal is typically referred to as a “lithium ion” battery. Insertion or “intercalation” electrodes contain materials having a lattice structure into which an ion can be inserted and subsequently extracted. Rather than chemically altering the intercalation material, the ions slightly expand the internal lattice lengths of the compound without extensive bond breakage or atomic reorganization. Insertion anodes contain, for example, lithium metal chalcogenide, lithium metal oxide, or carbon materials such as coke and graphite. These negative electrodes are used with lithium-containing insertion cathodes. In their initial condition, the cells are not charged, since the anode does not contain a source of cations. Thus, before use, such cells must be charged in order to transfer cations (lithium) to the anode from the cathode. During discharge the lithium is then transferred from the anode back to the cathode. During subsequent recharge, the lithium is again transferred back to the anode where it reinserts. This back-and-forth transport of lithium ions (Li+) between the anode and cathode during charge and discharge cycles had led to these cells as being called “rocking chair” batteries.

A variety of materials have been suggested for use as cathode active materials in lithium batteries. Such materials include, for example, MoS₂, MnO₂, TiS₂, NbSe₃, LiCoO₂, LiNiO₂, LiMn₂O₄, V₆O₁₃, V₂O₅, SO₂ CuCl₂. Transition metal oxides such as those of the general formula LiₓM₂O_{y}, are among those materials preferred in such batteries having intercalation electrodes. Other materials include lithium transition metal phosphates, such as LiFePO₄, and Li₃V₂(PO₄)₃. Such materials having structures similar to olivine or NASICON materials are among those known in the art.

In general, such a cathode material must exhibit a high free energy of reaction with lithium, be able to intercalate a large quantity of lithium, maintain its lattice structure upon insertion and extraction of lithium, allow rapid diffusion of lithium, afford good electrical conductivity, not be significantly soluble in the electrolyte system of the battery, and be readily and economically produced. However, many of the cathode materials known in the art lack one or more of these characteristics.

Transition metal oxides and transition metal phosphates are typically synthesized in a solid state reaction. Starting materials in particle form are mixed to produce an intimate mixture of particles. When heat is applied to effect reaction, the solid particles react with one another through a variety of surface reactions accompanied by diffusion of reactive materials into and out of the various particles in the mixture. For this reason, it is preferred to mix particle mixtures with as close a degree of contact as possible between the particles together with a desirable particle size. To accomplish this, the particle mixtures are typically prepared by non-attritive methods such as ball-milling or physical mixing. Because the active material particles may be relatively large and/or the sizes may be non uniform, optimum conditions of surface to surface contact between particles is often not achieved.

Close particle contact is even more important when the mixture of starting materials contains elemental carbon or other particulate material that serves as a reductant during the solid state reaction. For these reasons, it would be desirable to provide a new method for synthesizing battery active materials wherein a uniform mixture of very fine particles is heated, optionally in the presence of reducing agent, to produce a reaction product.

### SUMMARY OF THE INVENTION

The present invention relates to methods of preparing compounds using electromagnetic radiation. In particular, such methods comprise the steps of combining starting materials comprising at least one particulate metal compound and at least one source of carbon to form a mixture, and exposing the mixture to electromagnetic radiation to form the metal compound product. Preferably, the carbon is a reducing carbon, and at least one metal of the starting materials is reduced in oxidation state during radiation exposure.

The reaction may be carried out in a reducing atmosphere in the presence of reducing carbon. Carbon may be supplied by elemental carbon, by an organic material, or by mixtures thereof The organic material is one that can form decomposition products containing carbon, preferably in a form capable of acting as a reductant. The reaction proceeds without significant covalent incorporation of organic material into the reaction product. In a preferred embodiment, the solid state reactants also include an alkali metal compound.

In a preferred embodiment, the products of the method are electrode active materials useable in lithium ion batteries. Preferred active materials include lithium-transition metal phosphates and lithium-transition metal oxides. In a preferred embodiment, the reaction product contains carbon particles intimately mixed among particles of the active materials. Such products may be produced by mixing a metal compound with a source of carbon and exposing the mixture to electromagnetic radiation.

In one embodiment, the electromagnetic radiation is of a frequency generally regarded as being in the microwave region of the electromagnetic spectrum. In another embodiment, the frequency of the radiation used puts it into a region generally referred to as radio frequencies.

In a preferred embodiment, the reaction is carried out in a stoichiometric excess of carbon. The resulting reaction product contains a mixture of a metal compound with a carbonaceous material having a high atom percent of carbon. The organic material or carbonaceous material is not significantly covalently incorporated into the reaction product, but rather the carbonaceous material is intimately mixed with the product metal compound.

In another aspect, a reductive reaction of an alkali metal compound and a transition metal compound in the presence of reducing carbon is carried out in a reducing atmosphere. The reducing atmosphere may contain a reducing gas such as hydrogen, methane, ammonia, or carbon monoxide.

It has been found that the novel electrode materials made of the products of the present invention by the methods of this invention have benefits over materials made by processes among those known in the art. Such benefits include one or more of the following: increased capacity, enhanced cycling capability, enhanced reversibility, and reduced costs. Specific benefits and embodiments of the present invention are apparent from the detailed description set forth herein. It should be understood, however, that the detailed description and specific examples, while indicating embodiments among those preferred, are intended for purposes of illustration only and are not intended to limit the scope of the invention.

### DETAILED DESCRIPTION OF THE INVENTION

The present invention provides methods for synthesizing compounds comprising reduced metal compounds, preferably reduced transition metals, using electromagnetic radiation. In one aspect, the reaction products find use as battery active materials or as precursors for the synthesis of battery active materials.

In one aspect, the invention provides a method for synthesizing an inorganic metal compound, preferably a transition metal compound, by subjecting a mixture of starting materials including carbon to electromagnetic radiation, for example in the microwave region. The starting materials include at least one particulate metal compound and at least one source of carbon. In a preferred embodiment, the carbon is a source of reducing carbon, and at least one metal of the starting materials is reduced in oxidation state during radiation exposure.

In one aspect, the electrode active materials or other products made by the processes of this invention may be synthesized in single step reactions or in multi-step reactions. In at least one of the steps of the synthesis reaction, a source of reducing carbon is used as a starting material. The starting materials are then exposed to electromagnetic radiation in the microwave or radio frequency range. During the reductive step at least one metal is reduced in oxidation state.

Preferred processes of the present invention employ starting materials comprising at least one particulate metal compound and at least one source of reducing carbon. In one aspect, the metal compound includes a transition metal. In another aspect, the metal compound includes a non-transition element such as tin. (As used herein, the word “include,” and its variants, is intended to be non-limiting, such that recitation of items in a list is not to the exclusion of other like items that may also be useful in the materials, compositions, devices, and methods of this invention.) Preferred metals are accordingly selected from the group consisting of transition metals (defined as Groups 4-11 of the Periodic Table), as well as certain other non-transition metals such as tin, bismuth, and lead.

The reductant, which provides reducing power for the reactions, is provided in the form of a reducing carbon by including a source of elemental carbon or organic precursor along with the other particulate starting materials. In a preferred embodiment, the reducing power is provided by simultaneous oxidation of carbon to either carbon monoxide or carbon dioxide. The reducing carbon may be provided by elemental carbon, preferably in particulate form such as graphites, amorphous carbon, carbon blacks, fullerenes, and the like. Alternatively or in addition, reducing power may be provided by an organic precursor material comprising an organic material. The organic material is characterized as containing carbon and at least one other element, preferably hydrogen. The organic material generally forms a decomposition product, referred to herein as a carbonaceous material, upon exposure to radiation under the conditions of the reaction. Without being bound by theory, representative decomposition processes that can lead to the formation of the carbonaceous material include, without limitation, pyrolization, carbonization, coking, destructive distillation, and the like. These process names, as well as the term thermal decomposition, are used interchangeably in this application to refer to the process by which a decomposition product capable of acting as a reductant is formed upon exposure of a reaction mixture containing an organic material to electromagnetic radiation.

A typical decomposition product contains carbonaceous material. During reaction, at least a portion of the carbonaceous material formed is believed to participate as reductant. That portion that participates as reductant may form a volatile by-product such as discussed below. Any volatile by-product formed tends to escape from the reaction mixture so that it is not incorporated into the reaction product.

Although the invention is understood not to be limited as to the mechanism of action of the organic precursor material, it is believed that the carbonaceous material formed from decomposition of the organic material provides reducing power similar to that provided by elemental carbon discussed above. For example, the carbonaceous material may produce carbon monoxide or carbon dioxide, depending on the conditions of the reaction. Alternatively, if the reaction is carried out without reduction, it is believed that the organic material decomposes under the reaction conditions to form a carbonaceous material that is finely dispersed in the reaction product, leading to advantageous properties.

In some embodiments, some of the organic material providing reducing power may be oxidized to a non-volatile component, such as for example, oxygen-containing carbon materials such as, without limitation, alcohols, ketones, aldehydes, esters, and carboxylic acids and anhydrides. Such non-volatile by-products, as well as any carbonaceous material that does not participate as reductant (for example, any present in stoichiometric excess or any that does not otherwise react) will tend to remain in the reaction mixture along with the other reaction products, but will not be significantly covalently incorporated.

The carbonaceous material prepared by subjecting the organic precursor material to electromagnetic radiation will generally be enriched in carbon relative to the organic material. The carbonaceous material preferably contains from about 50 up to about 100 atom percent carbon. In a preferred embodiment, the carbonaceous material is essentially elemental carbon, with an atom percent of close to 100% carbon.

While, in some embodiments, the organic precursor material forms a carbonaceous decomposition product that acts as a reductant and/or nucleation site as discussed above, in other embodiments a portion of the organic material may participate as reductant without first undergoing a decomposition. The invention is not limited by the exact mechanism or mechanisms of the underlying reduction processes.

The organic precursor material may be any organic material capable of undergoing pyrolysis or carbonization, or any other decomposition process that leads to a carbonaceous material rich in carbon. Such precursors include in general any organic material, i.e., compounds characterized by containing carbon and at least one other element. Although the organic material may be a perhalo compound containing essentially no carbon-hydrogen bonds, typically the organic materials contain carbon and hydrogen. Other elements, such as without limitation halogens, oxygen, nitrogen, phosphorus, and sulfur, may be present in the organic material, as long as they do not significantly interfere with the decomposition process or otherwise prevent the reductions from being carried out. One example of a preferred organic material is coke, which contains mostly carbon and hydrogen. Other precursors include, without limitation, organic hydrocarbons, alcohols, esters, ketones, aldehydes, carboxylic acids, sulfonates, and ethers. Preferred precursors include the above species containing aromatic rings, especially the aromatic hydrocarbons such as tars, pitches, and other petroleum products or fractions. As used here, hydrocarbon refers to an organic compound made up of carbon and hydrogen, and containing no significant amounts of other elements. Hydrocarbons may contain impurities having some heteroatoms. Such impurities might result, for example, from partial oxidation of a hydrocarbon or incomplete separation of a hydrocarbon from a reaction mixture or natural source such as petroleum.

Other organic precursor materials include sugars and other carbohydrates, including derivatives and polymers. Examples of polymers include, without limitation, starch, cellulose, and their ether or ester derivatives. Other derivatives include, without limitation, the partially reduced and partially oxidized carbohydrates discussed below. It is believed that exposure to electromagnetic radiation heats the carbohydrates so that they decompose to form carbon and water. The term carbohydrates as used here encompasses the D-, L-, and DL-forms, as well as mixtures, and includes material from natural or synthetic sources.

Carbohydrates are organic materials that can be written with molecular formula (C)ₘ (H₂O)ₙ, where m and n are integers. For simple hexose or pentose sugars, m and n are equal to each other. Non-limiting examples of hexoses of formula C₆H₁₂O₆ include allose, altose, glucose, mannose, gulose, inose, galactose, talose, sorbose, tagatose, and fructose. Pentoses of formula C₅H₁₀O₅ are represented by, without limitation, ribose, arabinose, and xylose. Tetroses include erythrose and threose, while glyceric aldehyde is a triose. Other carbohydrates include the two-ring sugars (di-saccharides) of general formula C₁₂H₂₂O₁₁. Examples include, without limitation, sucrose, maltose, lactose, trehalose, gentiobiose, cellobiose, and melibiose. Three-ring (trisaccharides such as raffinose) and higher oligomeric and polymer carbohydrates may also be used. Non-limiting examples include starch and cellulose. As noted above, the carbohydrates readily decompose to carbon and water when microwaved at a sufficiently high power and for a sufficiently long time. The water of decomposition tends to turn to steam under the reaction conditions and volatilize.

It will be appreciated that other materials will also tend to readily decompose to H₂O and a material rich in carbon. Such materials are also intended to be included in the term “carbohydrate” as used in the invention. Such materials include slightly reduced carbohydrates such as, without limitation, glycerol, sorbitol, mannitol, iditol, dulcitol, talitol, arabitol, xylitol, and adonitol, as well as “slightly oxidized” carbohydrates such as, without limitation, gluconic, mannonic, glucuronic, galacturonic, mannuronic, saccharic, manosaccharic, ido-saccharic, mucic, talo-mucic, and allo-mucic acids. The formula of the slightly oxidized and the slightly reduced carbohydrates is similar to that of the carbohydrates.

A preferred carbohydrate is sucrose. Under the proper reaction conditions, sucrose melts. The liquid melt tends to distribute itself among the starting materials. At higher power and a longer time exposure, sucrose and other carbohydrates decompose to form carbon and water. The as-decomposed carbon powder is in the form of fresh amorphous fine particles with high surface area and high reactivity.

The organic precursor material may also be an organic polymer. Organic polymers include without limitation, polyolefins such as polyethylene and polypropylene, butadiene polymers, isoprene polymers, vinyl alcohol polymers, furfuryl alcohol polymers, styrene polymers including polystyrene, polystyrene-polybutadiene and the like, divinylbenzene polymers, naphthalene polymers, phenol condensation products including those obtained by reaction with aldehyde, polyacrylonitrile, polyvinyl acetate, as well as cellulose starch and esters and ethers thereof described above.

In some embodiments, the organic precursor material is a solid available in particulate form. Particulate materials may be combined with the other particulate starting materials and reacted according to the methods described above.

In other embodiments, the organic precursor material may be a liquid. In such cases, the liquid precursor material is combined with the other particulate starting materials to form a mixture. The mixture is exposed to electromagnetic radiation, whereupon the organic material forms a carbonaceous material in situ. The reaction proceeds with carbothermal reduction. The liquid precursor materials may also advantageously serve or function as a binder in the starting material mixture as noted above.

The starting materials are exposed to electromagnetic radiation, whereupon a reaction product forms. The specific radiation process depends upon factors including the specific radiation frequency employed, operating power, duration of time of exposure, and composition of the reaction materials.

The frequency of the electromagnetic radiation ranges from about 1 MHz (megahertz) to about 3000 GHz (gigahertz). Frequencies at the lower end of that range are generally called radio frequency, and the process can be called RF heating. Frequencies in the midrange are generally referred to as microwave, and those at the high end tend to be referred as infrared or far infrared.

In a preferred embodiment, the radiation is microwave to far-infrared and the frequency ranges from about 500 MHz to about 1000 GHz. Preferably the frequency is from about 500 MHz to about 100 GHz or from 500 MHz to 10 GHz. In a preferred embodiment, the frequency is from about 800 MHz to about 3 GHz. In a particularly preferred embodiment, the radiation frequency is about 900 MHz. In another particularly preferred embodiment, the radiation frequency is about 2.45 GHz. Power distribution may range from about 500 W to about 200 kW. Commercial microwaves are typically available below power settings of 75 kW. In a preferred embodiment, microwave radiation is produced by a magnetron, which comprises thermionic diodes equipped with heated cathodes acting as the source of electrons. The microwave radiation produced may be directed towards the microwave cavity using waveguides. Most commercial microwaves operate at single frequencies, however microwave radiation generators are known in the art having the capacity to monitor cavity temperature and adjust frequency and power accordingly. See for example U.S. Pat. No. 6,403,939 to Fagrell.

In another embodiment, the reaction is carried out with RF heating, and the radiation is in the radio frequency range. In this embodiment, the frequency typically ranges from about 1 MHz to about 100 MHz, preferably from about 10 to about 50 MHz. Particularly preferred frequencies are those approved by governmental authorities for industrial use, such as 13.56 MHz, 27.12 MHz and 40.68 MHz. Power output for RF heating generally ranges from about 1 kW to about 200 kW. Desirably, power output is from about 10 to about 100 kW. For the same electric field, the higher the frequency, the higher the power that may be transferred to the sample. Although radio waves have lower frequencies so that energy transfer tends to be less efficient, they have longer wavelengths, which leads to good sample uniformity and depth of penetration.

In a preferred embodiment, reactions are carried out by mixing the starting materials with reducing carbon and irradiating at a frequency and power and for a time sufficient to form a reaction product. Depending on the power level, the materials are exposed to electromagnetic radiation for a time of a few seconds to a few hours. As a rule, the higher the power level, the shorter are the required exposure times. The sample size will also control the time sufficient to form a reaction product. Typically, the larger the sample, the longer the time the starting materials must be exposed to the electromagnetic radiation. Desirably, the materials are exposed to the electromagnetic radiation for a time of about 10 seconds to about 30 minutes. Preferably, the materials are exposed to the electromagnetic radiation for a time of about 30 seconds to about 30 minutes. In another embodiment, exposure to electromagnetic radiation is for a time of about 1 minute to about 20 minutes, or for a time of about 1 minute to 10 minutes.

Processes:

In a preferred embodiment, the reaction is carried out with reduction, wherein at least one metal is reduced in oxidation state during irradiation. The reduction may be carried out in situ by including in the reaction mixture a reductant that will participate in the reaction to reduce the metal M, but that will preferably produce by-products that will not interfere with the active material when used later in an electrode or an electrochemical cell.

The starting material metal compound or compounds are mixed together with carbon, which is included in an amount sufficient to reduce the metal ion of one or more of the metal-containing starting materials without full reduction to an elemental metal state. Excess quantities of one or more starting materials (for example, about a 5 to 10% excess) may be used to enhance product quality. An excess of carbon, remaining after the reaction, functions as a conductive constituent in the ultimate electrode formulation. This is an advantage since such remaining carbon is very intimately mixed with the product active material. Accordingly, large quantities of excess carbon, on the order of 100% excess carbon or greater are useable in the process. The carbon present during compound formation is thought to be intimately dispersed throughout the precursor and product. The presence of carbon particles in the starting materials is thought to provide nucleation sites for the production of the product crystals. The reaction product is believed to be comprised of small grains or crystals nucleated onto carbon particles. The individual grains are agglomerated. This provides many advantages, including the enhanced conductivity of the product.

Reducing carbon is generally used in the reactions in stoichiometric excess. To calculate relative molar amounts of reducing carbon, it is convenient to use an “equivalent” weight of the reducing carbon, defined as the weight per gram-mole of carbon atom. For elemental carbons such as carbon black, graphite, and the like, the equivalent weight is about 12 g/equivalent. For other organic materials, the equivalent weight per gram-mole of carbon atoms is higher. For example, hydrocarbons have an equivalent weight of about 14 g/equivalent. Depending on the degree of unsaturation, the equivalent weight may be slightly above or below 14.

For organic materials having elements other than carbon and hydrogen, the equivalent weight for the purpose of calculating a stoichiometric quantity to be used in the reactions is higher than 14. For example, in carbohydrates it is about 30 g/equivalent. Examples of carbohydrates include sugars such as glucose, fructose, and sucrose, as well as polymers such as cellulose and starch.

Reactions with the organic precursor material are conveniently carried out by combining starting materials and exposing the combined starting materials to electromagnetic radiation. The starting materials include at least one metal compound or transition metal compound as noted above. In processes employing an organic material as a starting material it is preferred to carry out the decomposition of the organic material and a reduction in one step. In this embodiment, it is believed that microwave or other radiation heats the organic material so that it decomposes in the presence of the transition metal compound to form a decomposition product capable of acting as a reductant, which reacts with the transition metal compound to form a reduced transition metal compound. In another embodiment, the organic material may be decomposed in a separate step to form a decomposition product. The decomposition product may then be combined with a transition metal compound to form a mixture. The mixture may then be exposed to electromagnetic radiation for a time and at a power sufficient to form a reaction product.

In another aspect, reaction of a metal compound and a source of carbon is carried out without simultaneous reduction of a metal. In this aspect, the metal compounds are provided in an oxidation state equal to their oxidation state in the desired product. Whether or not reaction proceeds with carbothermal reduction, the carbon particles preferably provide nucleation sites for the crystals of the reaction product. The crystals or grains thus produced are preferably smaller than they would be in the absence of the carbon. The smaller grain size preferably leads to more intimate packing of the crystals forming a high quality active material. Preferably, carbon particles are also dispersed throughout the reaction product, leading to a product with good conductivity between grains. This is believed to contribute to the high quality of the active material made under carbothermal conditions.

Although the reactions may be carried out in oxygen or air, the irradiation is preferably conducted under an essentially non-oxidizing atmosphere. The atmosphere is essentially non-oxidizing so as not to interfere with the reduction reactions taking place. An essentially non-oxidizing atmosphere can be achieved through the use of vacuum, or through the use of inert gases such as argon, nitrogen, and the like. Although oxidizing gas (such as oxygen or air), may be present, it should not be at so great a concentration that it interferes with the carbothermal reduction or lowers the quality of the reaction product. It is believed that any oxidizing gas present will tend to react with the reducing carbon and lower the availability of the carbon for participation in the reaction. To some extent, such a contingency can be anticipated and accommodated by providing an appropriate excess of reducing carbon as a starting material. Nevertheless, it is generally preferred to carry out the carbothermal reduction in an atmosphere containing as little oxidizing gas as practical.

In a preferred embodiment, reduction is carried out in a reducing atmosphere in the presence of a reductant as discussed above. The term “reducing atmosphere” as used here means a gas or mixture of gases that is capable of providing reducing power for a reaction that is carried out in the atmosphere. Reducing atmospheres generally contain one or more so-called reducing gases. Non-limiting examples of reducing atmospheres include hydrogen, hydrogen-argon, hydrogen-nitrogen, carbon monoxide, carbon monoxide-hydrogen, carbon monoxide-argon, and the like. The reducing gas may, but need not be provided in molar excess. The reducing gas may be used in partial pressures from about 0.01 atmospheres up to super-atmospheric, depending on such factors as the size of the sample, the volume of the microwave, and the excess of gas, if any, required for the reaction. Reducing atmospheres are also generally characterized as having little or no oxidizing gases such as air or oxygen. If any oxidizing gas is present in the reducing atmosphere, it is at a level low enough that it does not significantly interfere with reduction processes going on.

Solid state materials, depending on their composition, interact differently with electromagnetic radiation. Electromagnetic radiation absorbers interact strongly with the electromagnetic radiation and subsequently get heated up very rapidly. In a preferred embodiment, the reaction materials comprise one or more electromagnetic radiation absorbers in addition to a carbon source. Electromagnetic radiation absorbers useful herein, without limitation include, oxides (e.g. MnO₂, Fe₃O₄, V₂O₅), sulfides (e.g. MoS₂, FeS₂), halides (e.g. CuCl, CuBr) and phosphates (e.g. NaH₂PO₄.xH₂O). Carbon materials such as graphite and amorphous carbon are also good microwave absorbers.

Preferred Electrode Active Material Products:

As discussed above, the methods of the present invention produce active materials (herein “electrode active materials”) comprising lithium or other alkali metals, at least one transition metal, and an anion. In one embodiment, the active materials are phosphate active materials, or active materials where other anions may completely or partially replace phosphate, of the general formula

AₐM_{b}(XY₄)_{c}Z_{d},

wherein

(a) A is selected from the group consisting of Li, Na, K, and mixtures thereof, and 0<a≦8;

(b) M is one or more metals, comprising at least one metal which is capable of undergoing oxidation to a higher valence state, and 1≦b≦3;

(c) XY₄ is selected from the group consisting of X′O₄₋ₓY′ₓ, X′O_{4-y}Y′_{2y}, X″S₄, and mixtures thereof, where X′ is selected from the group consisting of P, As, Sb, Si, Ge, V, S, and mixtures thereof; X″ is selected from the group consisting of P, As, Sb, Si, V, Ge and mixtures thereof; Y′ is selected from the group consisting of halogen S, N, mixtures thereof and; 0≦x≦3; and 0<y≦2; and 0<c≦3;

(d) Z is OH, halogen, or mixtures thereof, and 0≦d≦6; and

wherein M, X, Y, Z, a, b, c, d, x and y are selected so as to maintain electroneutrality of the compound.

Preferred embodiments include those where c=1, those where c=2, and those where c=3. Preferred embodiments include those where a≦1 and c=1, those where a=2 and c=1, and those where a≧3 and c=3. Preferred embodiments also include those having a structure similar to the mineral olivine (herein “olivines”), and those having a structure similar to NASICON (NA Super Ionic Conductor) materials (herein “NASICONs”).

In the formula above, A is selected from the group consisting of Li (lithium), Na (sodium), K (potassium), and mixtures thereof. In a preferred embodiment, A is Li, or a mixture of Li with Na, a mixture of Li with K, or a mixture of Li, Na and K. In another preferred embodiment, A is Na, or a mixture of Na with K. Preferably “a” is from about 0.1 to about 6, more preferably from about 0.2 to about 6. Where c=1, “a” is preferably from about 0.1 to about 3, preferably from about 0.2 to about 2. In a preferred embodiment, where c=1, “a” is less than about 1. In another preferred embodiment, where c=1, “a” is about 2. Where c=2, “a” is preferably from about 0.1 to about 6, preferably from about 1 to about 6. Where c=3, “a” is preferably from about 0.1 to about 6, preferably from about 2 to about 6, and more preferably from about 3 to about 6.

M comprises one or more metals, comprising at least one metal which is capable of undergoing oxidation to a higher valence state. In a preferred embodiment, removal of alkali metal from the electrode active material is accompanied by a change in oxidation state of at least one of the metals comprising M. The amount of the metal that is available for oxidation in the electrode active material determines the amount of alkali metal that may be removed. Such concepts are, in general application, well known in the art, e.g., as disclosed in U.S. Pat. No. 4,477,541, Fraioli, issued Oct. 16, 1984; and U.S. Pat. No. 6,136,472, Barker, et al., issued Oct. 24, 2000, both of which are incorporated by reference herein.

Referring to the general formula AₐM_{b}(XY₄)_{c}Z_{d}, the amount (a′) of alkali metal that can be removed, as a function of the quantity (b′) and valence (V^{M}) of oxidizable metal, is a′=b′(ΔV^{M}), where ΔV^{M} is the difference between the valence state of the metal in the active material and a valence state readily available for the metal. (The term oxidation state and valence state are used in the art interchangeably.) For example, for an active material comprising iron (Fe) in the +2 oxidation state, ΔV^{M}=1, wherein iron may be oxidized to the +3 oxidation state (although iron may also be oxidized to a +4 oxidation state in some circumstances). If b=2 (two atomic units of Fe per atomic unit of material), the maximum amount (a′) of alkali metal (oxidation state +1) that can be removed during cycling of the battery is 2 (two atomic units of alkali metal). If the active material comprises manganese (Mn) in the +2 oxidation state, ΔV^{M}=2, wherein manganese may be oxidized to the +4 oxidation state (although Mn may also be oxidized to higher oxidation states in some circumstances). Thus, in this example, the maximum amount (a′) of alkali metal that can be removed from a formula unit of active material during cycling of the battery is 4 atomic units, assuming that a≧4.

M may comprise a single metal, or a combination of two or more metals. In embodiments where M is a combination of elements, the total valence of M in the active material must be such that the resulting active material is electrically neutral (i.e., the positive charges of all anionic species in the material balance the negative charges of all cationic species), as further discussed below. The net valence of M (V^{M}) having a mixture of elements (M1, M2 . . . Mt) may be represented by the formula,

V^{M}=V^{M1}b₁+V^{M2}b₂+ . . . V^{Mt}bₜ,

where b₁+b₂+ . . . bₜ=1, and V^{M1} is the oxidation state of M1, V^{M2} is the oxidation state of M2, etc. (The net valence of M and other components of the electrode active material is discussed further, below.)

M may be, in general, a metal or metalloid, selected from the group consisting of elements from Groups 2-14 of the Periodic Table. As referred to herein, “Group” refers to the Group numbers (i.e., columns) of the Periodic Table as defined in the current IUPAC Periodic Table. See, e.g., U.S. Pat. No. 6,136,472, Barker et al., issued Oct. 24, 2000, incorporated by reference herein. In a preferred embodiment, M comprises one or more transition metals from Groups 4 to 11. In another preferred embodiment, M comprises a mixture of metals, M′ₑM″_{f}, where M′ is at least one transition metal from Groups 4 to 11, M″ is at least one element which is from Groups 2, 3, 12, 13, or 14; and e+f=b. In a preferred embodiment, 0.8≦a≦1.2 and 0.8≦b≦1.2

Transition metals useful herein include those selected from the group consisting of Ti (Titanium), V (Vanadium), Cr (Chromium), Mn (Manganese), Fe (Iron), Co (Cobalt), Ni (Nickel), Cu (Copper), Zr (Zirconium), Nb (Niobium), Mo (Molybdenum), Ru (Ruthenium), Rh (Rhodium), Pd (Palladium), Ag (Silver), Cd (Cadmium), Hf (Hafnium), Ta (Tantalum), W (Tungsten), Re (Rhenium), Os (Osmium), Ir (Iridium), Pt (Platinum), Au (Gold), Hg (Mercury), and mixtures thereof. Preferred are the first row transition series, selected from the group consisting of Ti, V, Cr, Mn, Fe, Co, Ni, Cu, and mixtures thereof. Particularly preferred transition metals useful here include Fe, Co, Mn, Cu, V, Cr, and mixtures thereof. In a preferred embodiment, the transition metals comprise Co and Fe. In some embodiments, mixtures of transition metals are preferred. Although, a variety of oxidation states for such transition metals are available, in some embodiments it is preferred that the transition metals have a +2 oxidation state.

M may also comprise non-transition metals and metalloids. Among such elements are those selected from the group consisting of Group 2 elements, particularly Be (Beryllium), Mg (Magnesium), Ca (Calcium), Sr (Strontium), Ba (Barium); Group 3 elements, particularly Sc (Scandium), Y (Yttrium), and the lanthanides, particularly La (Lanthanum), Ce (Cerium), Pr (Praseodymium), Nd (Neodymium), Sm (Samarium); Group 12 elements, particularly Zn (zinc) and Cd (cadmium); Group 13 elements, particularly B (Boron), Al (Aluminum), Ga (Gallium), In (Indium), Tl (Thallium); Group 14 elements, particularly Si (Silicon), Ge (Germanium), Sn (Tin), and Pb (Lead); Group 15 elements, particularly As (Arsenic), Sb (Antimony), and Bi (Bismuth); Group 16 elements, particularly Te (Tellurium); and mixtures thereof. Preferred non-transition metals include the Group 2 elements, Group 12 elements, Group 13 elements, and Group 14 elements. In a preferred embodiment, the non-transition metals have an oxidation state of +2 or +3. In another embodiment, the non-transition metals comprise at least one element in a +2 oxidation state and at least one element in a +3 oxidation state. Particularly preferred non-transition metals include Mg, Ca, Zn, Sr, Pb, Cd, Sn, Ba, Be, and Al. Particularly preferred are non-transition metals selected from the group consisting of Mg, Ca, Zn, Ba, Al, and mixtures thereof.

As further discussed herein, “b” is selected so as to maintain electroneutrality of the electrode active material. In a preferred embodiment, where c=1, “b” is from about 1 to about 2, preferably about 1. In another preferred embodiment, where c=2, “b” is from about 2 to about 3, preferably about 2. In another preferred embodiment, “d” is zero, “c” is about 1, 0.8≦a≦1.2, and 0.8≦b≦1.2.

XY₄ is selected from the group consisting of X′O₄₋ₓY′ₓ, X′O_{4-y}Y′_{2y}, X″S₄, and mixtures thereof, where X′ is P (phosphorus), As (arsenic), Sb (antimony), Si (silicon), Ge (germanium), S (sulfur), or mixtures thereof; X″ is P, As, Sb, Si, Ge or mixtures thereof. In a preferred embodiment, X′ and X″ are, respectively, selected from the group consisting of P, Si, and mixtures thereof. In a particularly preferred embodiment, X′ and X″ are P. Y′ is halogen, preferably F (fluorine). Preferred groups XY₄ include, without limitation, phosphate, silicate, sulfate, germanate, arsenate, antimonate, monofluoromonophosphate, difluoromonophosphate, and mixtures of the above, as well as the sulfur-containing analogs of the above.

In a preferred embodiment 0<x<3; and 0<y<4, such that a portion of the oxygen (O) in the XY₄ moiety is substituted with halogen. In another preferred embodiment, x and y are 0. In particularly preferred embodiment XY₄ is X′O₄, where X′ is preferably P or Si, and more preferably P.

Z is OH, halogen, or mixtures thereof. In one embodiment, “d” is equal to zero. In another preferred embodiment, “d” is non-zero and Z is selected from the group consisting of OH (hydroxyl), F (fluorine), Cl (chlorine), Br (bromine) and mixtures thereof. In a preferred embodiment, Z is OH. In another preferred embodiment, Z is F, or mixtures of F with OH, Cl, or Br. Preferably “d” is from about 0.1 to about 6, more preferably from about 0.2 to about 6. Where c=1, “d” is preferably from about 0.1 to about 3, preferably from about 0.2 to about 2. In a preferred embodiment, where c=1, “d” is about 1. Where c=2, “d” is preferably from about 0.1 to about 6, preferably from about 1 to about 6. Where c=3, “d” is preferably from about 0.1 to about 6, preferably from about 2 to about 6, preferably from about 3 to about 6.

The composition of M, X, Y, and Z, and the values of a, b, c, d, x and y, are selected so as to maintain electroneutrality of the electrode active material. As referred to herein “electroneutrality” is the state of the electrode active material wherein the sum of the positively charged species (e.g., M and X) in the material is equal to the sum of the negatively charged species (e.g., Y and Z) in the material. Preferably, the XY₄ moieties are comprised to be, as a unit moiety, an anion having a charge of −2, −3, or −4, depending on the selection of X.

Another preferred embodiment of an electrode active material produced by the method of the present invention is a compound of the formula

AₐM¹ₑM²_{f}M³_{g}XY₄,

wherein

(a) A is selected from the group consisting of Li, Na, K, and mixtures thereof, and 0<a≦2;

(b) M¹ is one or more transition metals, where e>0;

(c) M² is one or more +2 oxidation state non transition metals, where f>0;

(d) M³ is one or more +3 oxidation state non-transition metals, where g>0; and

(e) XY₄ is selected from the group consisting of X′O₄₋ₓY′ₓ, X′O_{4-y}Y′_{2y}, X″S₄, and mixtures thereof, where X′ is selected from the group consisting of P, As, Sb, Si, Ge, V, S, and mixtures thereof, X″ is selected from the group consisting of P, As, Sb, Si, Ge, V and mixtures thereof; Y′ is selected from the group consisting of halogen, S, N, and mixtures thereof, 0≦x≦3; and

0<y≦2; and

wherein e+f+g<2, and M¹, M², M³, XY₄, a, e, f, g, x, and y are selected so as to maintain electroneutrality of said compound. In embodiments where XY₄ is PO₄₋ₓY′ₓ and M¹ is a +2 oxidation state transition metal, a+2e+2f+3g=3−x.

Preferably, e+f+g=b. In a preferred embodiment 0<(e+f+g)≦1.5, more preferably 0.8≦(e+f+g)≦1.2, and even more preferably 0.9≦(e+f+g)≦1, wherein 0<(f+g)≦0.5, preferably 0.01≦(f+g)≦0.3, more preferably 0.05≦(f+g)≦0.2, and even more preferably 0.05≦(f+g)≦0.1.

In a preferred embodiment, A is Li. Preferably, M¹ is at least one transition metal from Groups 4 to 11 of the Periodic Table; M² is at least one non-transition metal from Groups 2, 12, or 14-16 of the Periodic Table, and M³ is a +3 oxidation state metal selected from Group 13. Preferably M¹ is selected from the group consisting of Fe, Co, Ni, Mn, Cu, V, Zr, Ti, Cr, and mixtures thereof; more preferably M¹ is a +2 oxidation state transition metal selected from the group consisting of Fe, Co, Mn, Cu, V, Cr, and mixtures thereof. In a preferred embodiment, M¹ additionally comprises Ti. Preferably M² is selected from the group consisting +2 oxidation state non-transition metals and mixtures thereof; more preferably M² is selected from the group consisting of Be, Mg, Ca, Sr, Ba, Ra, Zn, Cd, Hg and mixtures thereof. M³ is a +3 oxidation state non-transition metal, preferably selected from Group 13, more preferably Sc, Y, La, Ac, B, Al, Ga, In, Tl and mixtures thereof. Preferably M³ is Al. Preferably 0<(f+g)≦0.5, preferably 0.01≦(f+g)≦0.3, more preferably 0.05≦(f+g)≦0.1. Preferably, 0.01≦f≦0.3, more preferably 0.05≦f≦0. 1, and even more preferably 0.01≦f≦0.03. Also preferably, 0.01≦g≦0.3, more preferably 0.05≦g≦0.1, and even more preferably 0.01≦g≦0.03.

Another preferred embodiment produces a compound having an olivine structure. During charge and discharge of the battery, lithium ions are added to, and removed from, the active material preferably without substantial changes in the crystal structure of the material. Such materials have sites for the alkali metal (e.g., Li), the transition metal (M), and the XY₄ (e.g., phosphate) moiety. In some embodiments, all sites of the crystal structure are occupied. In other embodiments, some sites may be unoccupied, depending on, for example, the oxidation states of the metal (M). Among such preferred compounds are those of the formula

LiM(PO₄₋ₓY′ₓ)

wherein M is M¹_{g}M²ₕM³ᵢM⁴ⱼ, and

(a) M¹ is one or more transition metals;

(b) M² is one or more +2 oxidation state non-transition metals;

(c) M³ is one or more +3 oxidation state non-transition metals;

(d) M⁴ is one or more +1 oxidation state non-transition metals; and

(e) Y′ is halogen, preferably fluoride; and

each of g and i>0; each of h and j≧0; (g+h+i+j)≦1; 0≦x≦0.5; and the net valence of M is 2−x. Preferably, g≧0.8, more preferably, g≧0.9. Preferably, M¹ is a +2 oxidation state transition metal selected from the group consisting of V, Cr, Mn, Fe, Co, Ni, and mixtures thereof. More preferably, M¹ is selected from the group consisting of Fe, Co, and mixtures thereof. In a preferred embodiment, M¹ additionally comprises Ti.

Preferably, (h+i)>0, more preferably, 0.02≦(h+i)≦0.5, more preferably, 0.02≦(h+i)≦0.3. Preferably, 0.01≦h≦0.2, more preferably, 0.01≦h≦0.1. Preferably, M² is selected from the group consisting of Be, Mg, Ca, Sr, Ba, and mixtures thereof. Preferably, 0.01≦i≦0.2, more preferably, 0.01≦i≦0.1. Preferably, M³ is Al.

In one embodiment, j=0. In another embodiment, 0.01≦j≦0.1. Preferably, M⁴ is selected from the group consisting of Li, Na, and K. More preferably, M⁴ is Li.

In one embodiment, x=0. In another embodiment, 0<x≦1. In such an embodiment, preferably, 0.01≦x≦0.05, and (g+h+i+j)≦1. In an embodiment where j=0, preferably, (g+h+i)=1−x.

Another preferred embodiment produces a compound of the formula

LiₐCoₑFe_{f}M¹_{g}M²ₕM³ᵢXY₄

wherein

(a) 0<a≦2, e>0, and f>0;

(b) M¹ comprises one or more transition metals, where g≧0;

(c) M² comprises one or more +2 oxidation state non-transition metals, where h≧0;

(d) M³ comprises one or more +3 oxidation state non-transition metals, where i≧0; and

(e) XY₄ is selected from the group consisting of X′O₄₋ₓY′ₓ, X′O_{4-y}Y′_{2y}, X″S₄, and mixtures thereof, where X′ is selected from the group consisting of P, As, Sb, Si, Ge, V, S, and mixtures thereof; X″ is selected from the group consisting of P, As, Sb, Si, Ge, V, and mixtures thereof; Y′ is selected from the group consisting of halogen, N, and mixtures thereof; 0≦x≦3; and 0<y≦2; and

wherein (e+f+g+h+i)≦2, and M¹, M², M³, XY₄, a, e, f, g, h, i, x, and y are selected so as to maintain electroneutrality of said compound. Preferably, 0.8≦(e+f+g+h+i)≦1.2, more preferably 0.9≦(e+f+g+h+i)≦1. Preferably, e≧0.5, more preferably, e≧0.8. Preferably, 0.01≦f≦0.5, more preferably, 0.05≦f≦0.15. Preferably, 0.01≦g≦0.5, more preferably, 0.05≦g≦0.2. Preferably M¹ is selected from the group consisting of Ti, V, Cr, Mn, Ni, Cu and mixtures thereof. Preferably, M¹ is selected from the group consisting of Mn, Ti, and mixtures thereof. Preferably, (h+i)>0, more preferably 0.01≦(h+i)≦0.5, more preferably 0.02≦(h+i)≦0.3. Preferably, 0.01≦h≦0.2, more preferably, 0.01≦h≦0.1. Preferably, M² is selected from the group consisting of Be, Mg, Ca, Sr, Ba, and mixtures thereof. More preferably, M² is Mg. Preferably, 0.01≦i≦0.2, more preferably 0.01≦i≦0.1. Preferably, M³ is selected from the group consisting of B, Al, Ga, In and mixtures thereof. More preferably, M³ is Al.

In one embodiment, XY₄ is PO₄. In another embodiment, XY₄ is PO₄₋ₓFₓ, and 0<x≦1, preferably, 0.01≦x≦0.05.

Another preferred embodiment produces a compound of the formula:

AₐM_{b}(XY₄)₃Z_{d},

wherein

(a) A is selected from the group consisting of Li, Na, K, and mixtures thereof, and 2≦a≦9;

(b) M comprises one or more metals, comprising at least one metal which is capable of undergoing oxidation to a higher valence state, and 1≦b≦3;

(c) XY₄ is selected from the group consisting of X′O₄₋ₓY′ₓ, X′O_{4-y}Y′_{2y}, X″S₄, and mixtures thereof, where X′ is selected from the group consisting of P, As, Sb, Si, Ge, V, S, and mixtures thereof; X″ is selected from the group consisting of P, As, Sb, Si, Ge, V, and mixtures thereof, Y′ is selected from the group consisting of halogen, S, N, and mixtures thereof; 0≦x<3; and 0<y<4; and

(d) Z is OH, halogen, or mixtures thereof, and 0≦d≦6; and wherein M, XY₄, Z, a, b, d, x and y are selected so as to maintain electroneutrality of said compound. In a preferred embodiment, A comprises Li, or mixtures of Li with Na or K. In another preferred embodiment, A comprises Na, K, or mixtures thereof. In a preferred embodiment, M comprises two or more transition metals from Groups 4 to 11 of the Periodic Table, preferably transition metals selected from the group consisting of Fe, Co, Ni, Mn, Cu, V, Zr, Ti, Cr, and mixtures thereof In another preferred embodiment, M comprises M′₁₋ₘM″ₘ, where M′ is at least one transition metal from Groups 4 to 11 of the Periodic Table; and M″ is at least one element from Groups 2, 3, and 12-16 of the Periodic Table; and 0<m<1. Preferably, M′ is selected from the group consisting of Fe, Co, Ni, Mn, Cu, V, Zr, Ti, Cr, and mixtures thereof; more preferably M′ is selected from the group consisting of Fe, Co, Mn, Cu, V, Cr, and mixtures thereof. Preferably, M″ is selected from the group consisting of Mg, Ca, Zn, Sr, Pb, Cd, Sn, Ba, Be, Al, and mixtures thereof; more preferably, M″ is selected from the group consisting of Mg, Ca, Zn, Ba, Al, and mixtures thereof. In a preferred embodiment, XY₄ is PO₄. In another preferred embodiment, X′ comprises As, Sb, Si, Ge, S, and mixtures thereof; X″ comprises As, Sb, Si, Ge and mixtures thereof, and 0<x<3. In a preferred embodiment, Z comprises F, or mixtures of F with Cl, Br, OH, or mixtures thereof. In another preferred embodiment, Z comprises OH, or mixtures thereof with Cl or Br.

Non-limiting examples of active materials of the invention include the following: Li_{0.95}Co_{0.8}Fe_{0.15}Al_{0.05}PO₄, Li_{1.025}Co_{0.85}Fe_{0.05}Al_{0.025}Mg_{0.05}PO₄, Li_{1.025}Co_{0.80}Fe_{0.10}Al_{0.025}Mg_{0.05}PO₄, Li_{1.025}Co_{0.45}Fe_{0.45}Al_{0.025}Mg_{0.05}PO₄, Li_{1.025}Co_{0.75}Fe_{0.15}Al_{0.025}Mg_{0.05}PO₄, Li_{1.025}Co_{0.7}(Fe_{0.4}Mn_{0.6})_{0.2}Al_{0.025}Mg_{0.05}PO₄, Li_{1.025}Co_{0.75}Fe_{0.15}Al_{0.025}Mg_{0.05}PO₄, Li_{1.025}Co_{0.85}Fe_{0.05}Al_{0.025}Mg_{0.05}PO₄, Li_{1.025}Co_{0.7}Fe_{0.08}Mn_{0.12}Al_{0.025}Mg_{0.05}PO₄, LiCo_{0.75}Fe_{0.15}Al_{0.025}Ca_{0.05}PO_{3.975}F_{0.025}, LiCo_{0.80}Fe_{0.10}Al_{0.025}Ca_{0.05}PO_{3.975}F_{0.025}, Li_{1.25}Co_{0.6}Fe_{0.1}Mn_{0.075}Mg_{0.025}Al_{0.05}PO₄, Li_{1.0}Na_{0.25}Co_{0.6}Fe_{0.1}Cu_{0.075}Mg_{0.025}Al_{0.05}PO₄, Li_{1.025}Co_{0.8}Fe_{0.1}Al_{0.025}Mg_{0.075}PO₄, Li_{1.025}Co_{0.6}Fe_{0.05}Al_{0.12}Mg_{0.0325}PO_{3.75}F_{0.25}, Li_{1.025}Co_{0.7}Fe_{0.1}Mg_{0.0025}Al_{0.04}PO_{3.75}F_{0.25}, Li_{0.75}Co_{0.5}Fe_{0.05}Mg_{0.015}Al_{0.04}PO₃F, Li_{0.75}Co_{0.5}Fe_{0.025}Cu_{0.025}Be_{0.015}Al_{0.04}PO₃F, Li_{0.75}Co_{0.5}Fe_{0.025}Mn_{0.025}Ca_{0.015}Al_{0.04}PO₃F, Li_{1.025}Co_{0.6}Fe_{0.05}B_{0.12}Ca_{0.0325}PO_{3.75}F_{0.25}, Li_{1.025}Co_{0.65}Fe_{0.05}Mg_{0.0125}Al_{0.1}PO_{3.75}F_{0.25}, Li_{1.025}Co_{0.65}Fe_{0.05}Mg_{0.065}Al_{0.14}PO_{3.975}F_{0.025}, Li_{1.075}Co_{0.8}Fe_{0.05}Mg_{0.025}Al_{0.05}PO_{3.975}F_{0.025}, LiCo_{0.8}Fe_{0.1}Al_{0.0125}Mg_{0.05}PO_{3.975}F_{0.025}, Li_{0.25}Fe_{0.7}Al_{0.45}PO₄, LiMnAl_{0.067}(PO₄)_{0.8}(SiO₄)_{0.2}, Li_{0.95}Co_{0.9}Al_{0.05}Mg_{0.05}PO₄, Li_{0.95}Fe_{0.8}Ca_{0.15}Al_{0.05}PO₄, Li_{0.25}MnBe_{0.425}Ga_{0.3}SiO₄, Li_{0.5}Na_{0.25}Mn_{0.6}Ca_{0.375}Al_{0.1}PO₄, Li_{0.25}Al_{0.25}Mg_{0.25}Co_{0.75}PO₄, Na_{0.55}B_{0.15}Ni_{0.75}Ba_{0.25}PO₄, Li_{1.025}Co_{0.9}Al_{0.025}Mg_{0.05}PO₄, K_{1.025}Ni_{0.09}Al_{0.025}Ca_{0.05}PO₄, Li_{0.95}Co_{0.9}Al_{0.05}Mg_{0.05}PO₄, Li_{0.95}Fe_{0.8}Ca_{0.15}Al_{0.05}PO₄, Li_{1.025}Co_{0.7}(Fe_{0.4}Mn_{0.6})_{0.2}Al_{0.025}Mg_{0.05}PO_{4,}, Li_{1.025}Co_{0.8}Fe_{0.1}Al_{0.025}Mg_{0.05}PO₄, Li_{1.025}Co_{0.9}Al_{0.025}Mg_{0.05}PO₄, Li_{1.025}Co_{0.75}Fe_{0.15}Al_{0.025}Mg_{0.025}PO₄, LiCo_{0.75}Fe_{0.15}Al_{0.025}Ca_{0.05}PO_{3.975}F_{0.025}, LiCo_{0.9}Al_{0.025}Mg_{0.05}PO_{3.975}F_{0.025}, Li_{0.75}Co_{0.625}Al_{0.25}PO_{3.75}F_{0.25}, Li_{1.075}Co_{0.8}Cu_{0.05}Mg_{0.025}Al_{0.05}PO_{3.975}F_{0.025}, Li_{1.075}Fe_{0.8}Mg_{0.075}Al_{0.05}PO_{3.975}F_{0.025}, Li_{1.075}Co_{0.8}Mg_{0.075}Al_{0.05}PO_{3.975}F_{0.025}, Li_{1.025}Co_{0.8}Mg_{0.1}Al_{0.05}PO_{3.975}F_{0.025}, LiCo_{0.7}Fe_{0.2}Al_{0.025}Mg_{0.05}PO_{3.975}F_{0.025}, Li₂Fe_{0.8}Mg_{0.2}PO₄F; Li₂Fe_{0.5}Co_{0.5}PO₄F; Li₃CoPO₄F_{2;} KFe(PO₃F)F; Li₂Co(PO₃F)Br₂; Li₂Fe(PO₃F₂)F; Li₂FePO₄Cl; Li₂MnPO₄OH; Li₂CoPO₄F; Li₂Fe_{0.5}Co_{0.5}PO₄F; Li₂Fe_{0.9}Mg_{0.1}PO₄F; Li₂Fe_{0.8}Mg_{0.2}PO₄F; Li_{1.25}Fe_{0.9}Mg_{0.1}PO₄F_{0.25}; Li₂MnPO₄F; Li₂CoPO₄F; K₂Fe_{0.9}Mg_{0.1}P_{0.5}As_{0.5}O₄F; Li₂MnSbO₄OH; Li₂Fe_{0.6}Co_{0.4}SbO₄Br; Na₃CoAsO₄F₂; LiFe(AsO₃F)Cl; Li₂Co(As_{0.5}Sb_{0.5}O₃F)F₂; K₂Fe(AsO₃F₂)F; Li₂NiSbO₄F; Li₂FeAsO₄OH; Li₄Mn₂(PO₄)₃F; Na₄FeMn(PO₄)₃OH; Li₄FeV(PO₄)₃Br; Li₃VAl(PO₄)₃F; K₃VAl(PO₄)₃Cl; LiKNaTiFe(PO₄)₃F; Li₄Ti₂(PO₄)₃Br; Li₃V₂(PO₄)₃F₂; Li₆FeMg(PO₄)₃OH; Li₄Mn₂(AsO₄)₃F; K₄FeMn(AsO₄)₃OH; Li₄FeV(P_{0.5}Sb_{0.5}O₄)₃Br; LiNaKAlV(AsO₄)₃F; K₃VAl(SbO₄)₃Cl; Li₃TiV(SbO₄)₃F; Li₂FeMn(P_{0.5}As_{0.5}O₃F)₃; Li₄Ti₂(PO₄)₃F; Li_{3.25}V₂(PO₄)₃F_{0.25}; Li₃Na_{0.75}Fe₂(PO₄)₃F_{0.75}, Na_{6.5}Fe₂(PO₄)₃(OH)Cl_{0.5;} K₈Ti₂(PO₄)₃F₃Br₂; K₈Ti₂(PO₄)₃F₅; Li₄Ti₂(PO₄)₃F; LiNa_{1.25}V₂(PO₄)₃F_{0.5}Cl_{0.75}; K_{3.25}Mn₂(PO₄)₃OH_{0.25}; LiNa_{1.25}KTiV(PO₄)₃(OH)_{1.25}Cl; Na₈Ti₂(PO₄)₃F₃Cl₂; Li₇Fe₂(PO₄)₃F₂; Li₈FeMg(PO₄)₃F_{2.25}Cl_{0.75}; Li₅Na_{2.5}TiMn(PO₄)₃(OH)₂Cl_{0.5}; Na₃K_{4.5}MnCa(PO₄)₃(OH)_{1.5}Br; K₉FeBA(PO₄)₃F₂Cl₂, Li₇Ti₂(SiO₄)₂(PO₄)F₂; Na₈Mn₂(SiO₄)₂(PO₄)F₂Cl; Li₃K₂V₂(SiO₄)₂(PO₄)(OH)Cl; Li₄Ti₂(SiO₄)₂(PO₄)(OH); Li₂NaKV₂(SiO₄)₂(PO₄)F; Li₅TiFe(PO₄)₃F; Na₄K₂VMg(PO₄)₃FCl; Li₄NaAlNi(PO₄)₃(OH); Li₄K₃FeMg(PO₄)₃F_{2;} Li₂Na₂K₂CrMn(PO₄)₃(OH)Br; Li₅TiCa(PO₄)₃F; Li₄Ti_{0.75}Fe_{1.5}(PO₄; Li₃NaSnFe(PO₄)₃(OH); Li₃NaGe_{0.5}Ni₂(PO₄)₃(OH); Na₃K₂VCo(PO₄)₃(OH)Cl; Li₄Na₂MnCa(PO₄)₃F(OH); Li₃NaKTiFe(PO₄)₃F; Li₇FeCo(SiO₄)₂(PO₄)F; Li₃Na₃TiV(SiO₄)₂(PO₄)F; K_{5.5}CrMn(SiO₄)₂(PO₄)Cl_{0.5}; Li₃Na_{2.5}V₂(SiO₄)₂(PO₄)(OH)_{0.5}; Na_{5.25}FeMn(SiO₄)₂(PO₄)Br_{0.25}; Li_{6.5}VCo(SiO₄)_{2.5}(PO₄)_{0.5}F; Na_{7.25}V₂(SiO₄)_{2.25}(PO₄)_{0.75}F₂; Li₄NaVTi(SiO₄)₃F_{0.5}Cl_{0.5}; Na₂K_{2.5}ZrV(SiO₄)₃F_{0.5}; Li₄K₂MnV(SiO₄)₃(OH)₂; Li₃Na₃KTi₂(SiO₄)₃F; K₆V₂(SiO₄)₃(OH)Br; Li₈FeMn(SiO₄)₃F₂; Na₃K_{4.5}MnNi(SiO₄)₃(OH)_{1.5}; Li₃Na₂K₂TiV(SiO₄)₃(OH)_{0.5}Cl_{0.5}; K₉VCr(SiO₄)₃F₂Cl; Li₄Na₄V₂(SiO₄)₃FBr; Li₄FeMg(SO₄)₃F₂; Na₂KNiCo(SO₄)₃(OH); Na₅MnCa(SO₄)₃F₂Cl; Li₃NaCoBa(SO₄)₃FBr; Li_{2.5}K_{0.5}FeZn(SO₄)₃F; Li₃MgFe(SO₄)₃F₂; Li₂NaCaV(SO₄)₃FCl; Na₄NiMn(SO₄)₃(OH)₂; Na₂KBaFe(SO₄)₃F; Li₂KCuV(SO₄)₃(OH)Br; Li_{1.5}CoPO₄F_{0.5}; Li_{1.25}CoPO₄F_{0.25}; Li_{1.75}FePO₄F_{0.75}; Li_{1.66}MnPO₄F_{0.66}; Li_{1.5}Co_{0.75}Ca_{0.25}PO₄F_{0.5}; Li_{1.75}Co_{0.8}Mn_{0.2}PO₄F_{0.75}; Li_{1.25}Fe_{0.75}Mg_{0.25}PO₄F_{0.25}; Li_{1.66}Co_{0.6}Zn_{0.4}PO₄F_{0.66}; KMn₂SiO₄Cl; Li₂VSiO₄(OH)₂; Li₃CoGeO₄F; LiMnSO₄F; NaFe_{0.9}Mg_{0.1}SO₄Cl; LiFeSO₄F; LiMnSO₄OH; KMnSO₄F; Li_{1.75}Mn_{0.8}Mg_{0.2}PO₄F_{0.75}; Li₃FeZn(PO₄)F₂; Li_{0.5}V_{0.75}Mg_{0.5}(PO₄)F_{0.75}; Li₃V_{0.5}Al_{0.5}(PO₄)F_{3.5}; Li_{0.75}VCa(PO₄)F_{1.75}; Li₄CuBa(PO₄)F₄; Li_{0.5}V_{0.5}Ca(PO₄)(OH)_{1.5}; Li_{1.5}FeMg(PO₄)(OH)Cl; LiFeCoCa(PO₄)(OH)₃F; Li₃CoBa(PO₄)(OH)₂Br₂; Li_{0.75}Mn_{1.5}Al(PO₄)(OH)_{3.75}; Li₂Co_{0.75}Mg_{0.25}(PO₄)F; LiNaCo_{0.8}Mg_{0.2}(PO₄)F; NaKCo_{0.5}Mg_{0.5}(PO₄)F; LiNa_{0.5}K_{0.5}Fe_{0.75}Mg_{0.25}(PO₄)F; Li_{1.5}K_{0.5}V_{0.5}Zn_{0.5}(PO₄)F₂; Na₆Fe₂Mg(PS₄)₃(OH₂)Cl; Li₄Mn_{1.5}Co_{0.5}(PO₃F)₃(OH)_{3.5}; K₈FeMg(PO₃F)₃F₃Cl₃ Li₅Fe₂Mg(SO₄)₃Cl₅; LiTi₂(SO₄)₃Cl, LiMn₂(SO₄)₃F, Li₃Ni_{(SO}₄)₃Cl, Li₃Co₂(SO₄)₃F, Li₃Fe₂(SO₄)₃Br, Li₃Mn₂(SO₄)₃F, Li₃MnFe(SO₄)₃F, Li₃NiCo(SO₄)₃Cl; LiMnSO₄F; LiFeSO₄Cl; LiNiSO₄F; LiCoSO₄Cl; LiMn₁₋ₓFeₓSO₄F, LiFe₁₋ₓMgₓSO₄F; Li₇ZrMn(SiO₄)₃F; Li₇MnCo(SiO₄)₃F; Li₇MnNi(SiO₄)₃F; Li₇VAl(SiO₄)₃F; Li₅MnCo(PO₄)₂(SiO₄)F; Li₄VAl(PO₄)₂(SiO₄)F; Li₄MnV(PO₄)₂(SiO₄)F; Li₄VFe(PO₄)₂(SiO₄)F; Li_{0.6}VPO₄F_{0.6}; Li_{0.8}VPO₄F_{0.8}; LiVPO₄F; Li₃V₂(PO₄)₂F₃; LiVPO₄Cl; LiVPO₄OH; NaVPO₄F; Na₃V₂(PO₄)₂F₃; LiV_{0.9}Al_{0.1}PO₄F; LiFePO₄F; LiTiPO₄F; LiCrPO₄; LiFePO₄; LiFe_{0.9}Mg_{0.1}PO₄; LiFe_{0.8}Mg_{0.2}PO₄; LiFe_{0.95}Mg_{0.05}PO₄; LiFe_{0.9}Ca_{0.1}PO₄; LiFe_{0.8}Ca_{0.2}PO₄; LiFe_{0.8}Zn_{0.2}PO₄; Li₃V₂(PO₄)₃; Li₃Fe₂(PO₄)₃; Li₃Mn₂(PO₄)₃; Li₃FeTi(PO₄)₃; Li₃CoMn(PO₄)₃; Li₃FeV(PO₄)₃; Li₃VTi(PO₄)₃; Li₃FeCr(PO₄)₃; Li₃FeMo(PO₄)₃; Li₃FeNi(PO₄)₃; Li₃FeMn(PO₄)₃; Li₃FeAl(PO₄)₃; Li₃FeCo(PO₄)₃; Li₃Ti₂(PO₄)₃; Li₃TiCr(PO₄)₃; Li₃TiMn(PO₄)₃; Li₃TiMo(PO₄)₃; Li₃TiCo(PO₄)₃; Li₃TiAl(PO₄)₃; Li₃TiNi(PO₄)₃; Li₃ZrMnSiP₂O₁₂; Li₃V₂SiP₂O₁₂; Li₃MnVSiP₂O₁₂; Li₃TiVSiP₂O₁₂; Li₃TiCrSiP₂O₁₂; Li_{3.5}AlVSi_{0.5}P_{2.5}O₁₂; Li_{3.5}V2Si_{0.5}P_{2.5}O₁₂; Li_{2.5}AlCrSi_{0.5}P_{2.5}O₁2; Li_{2.5}V₂P₃O_{11.5}F_{0.5}; Li₂V₂P₃O₁₁F; Li_{2.5}VMnP₃O_{11.5}F_{0.5}; Li₂V_{0.5}Fe_{1.5}P₃O₁₁F; Li₃V_{0.5}V_{1.5}P₃O_{11.5}F_{0.5}; Li₃V₂P₃O₁₁F; Li₃Mn_{0.5}V_{1.5}P₃O₁₁F_{0.5}; LiCo_{0.8}Fe_{0.1}Ti_{0.025}Mg_{0.05}PO_{4;} Li_{1.025}Co_{0.8}Fe_{0.1}Ti_{0.025}Al_{0.025}PO₄; L_{1.025}Co_{0.8}Fe_{0.1}Ti_{0.025}Mg_{0.025}PO_{3.975}F_{0.025}; LiCo_{0.825}Fe_{0.1}Ti_{0.025}Mg_{0.025}PO₄; LiCo_{0.85}Fe_{0.075}Ti_{0.025}Mg_{0.025}PO₄; LiCo_{0.8}Fe_{0.1}Ti_{0.025}Al_{0.025}Mg_{0.025}PO_{4,} Li_{1.025}Co_{0.8}Fe_{0.1}Ti_{0.025}Mg_{0.05}PO₄, Li_{1.025}Co_{0.8}Fe_{0.1}Ti_{0.025}Al_{0.025}Mg_{0.025}PO₄, LiCo_{0.8}Fe_{0.1}Ti_{0.05}PO₄, LiVOPO₄, Li(VO)_{0.75}Mn_{0.25}PO₄, NaVOPO₄, Li_{0.75}Na_{0.25}VOPO₄, Li(VO)_{0.5}Al_{0.5}PO₄, Na(VO)_{0.75}Fe_{0.25}PO₄, Li_{0.5}Na_{0.5}VOPO₄, Li(VO)_{0.75}Co_{0.25}PO₄, Li(VO)_{0.75}MO_{0.25}PO₄, LiVOSO₄, and mixtures thereof.

Preferred active materials include LiFePO₄; LiFe_{0.9}Mg_{0.1}PO₄; LiFe_{0.8}Mg_{0.2}PO_{4,} LiFe_{0.95}Mg_{0.05}PO₄; Li_{1.025}Co_{0.85}Fe_{0.05}Al_{0.025}Mg_{0.05}PO₄, Li_{1.025}Co_{0.80}Fe_{0.10}Al_{0.025}Mg_{0.05}PO₄, Li_{1.025}Co_{0.75}Fe_{0.15}Al_{0.025}Mg_{0.05}PO₄, Li_{1.025}Co_{0.7}(Fe_{0.4}Mn_{0.6})_{0.2}Al_{0.025}Mg_{0.05}PO₄, LiCo_{0.8}Fe_{0.1}Al_{0.025}Ca_{0.05}PO_{3.975}F_{0.025}, LiCo_{0.8}Fe_{0.1}Al_{0.025}Mg_{0.05}PO_{3.975}F_{0.025}, LiCo_{0.8}Fe_{0.1}Ti_{0.025}Mg_{0.05}PO₄; Li_{1.025}Co_{0.8}Fe_{0.1}Ti_{0.025}Al_{0.025}PO₄; Li_{1.025}Co_{0.8}Fe_{0.1}Ti_{0.025}Mg_{0.025}PO_{3.975}F_{0.025}; LiCo_{0.825}Fe_{0.1}Ti_{0.025}Mg_{0.025}PO₄; LiCo_{0.85}Fe_{0.075}Ti_{0.025}Mg_{0.025}PO₄; LiVOPO₄; Li(VO)_{0.75}Mn_{0.25}PO₄; and mixtures thereof. A particularly preferred active material is LiCo_{0.8}Fe_{0.1}Al_{0.025}Mg_{0.05}PO_{3.975}F_{0.025}

In an embodiment of this invention, active materials of this invention comprise alkali metal transition metal oxides of the formula AₑM_{f}O_{g}. Such embodiments comprise compounds of the formula A²ₑM²_{f}O_{g}.

A² is selected from the group consisting of Li (lithium), Na (sodium), K (potassium), and mixtures thereof. In a preferred embodiment, A² is Li, or a mixture of Li with Na, a mixture of Li with K, or a mixture of Li, Na and K. In another preferred embodiment, A² is Na, or a mixture of Na with K. Preferably “e” is from about 0.1 to about 6, more preferably from about 0.1 to about 3, and even more preferably from about 0.2 to about 2.

M² comprises one or more metals, comprising at least one metal which is capable of undergoing oxidation to a higher valence state. In a preferred embodiment, removal of alkali metal from the electrode active material is accompanied by a change in oxidation state of at least one of the metals comprising M². The amount of the metal that is available for oxidation in the electrode active material determined the amount of alkali metal that may be removed. Such concepts for oxide active materials are well known in the art, e.g., as disclosed in U.S. Pat. Nos. 4,302,518 and 4,357,215 issued to Goodenough et al; and U.S. Pat. No. 5,783,333, Mayer, issued Jul. 21, 1998, all of which are incorporated by reference herein.

Similar to the oxidation process described above for formula A¹ₐM¹_{b}(XY₄)_{c}Z_{d}, the oxidation process for A²ₑM²_{f}O_{g} reflects the amount (e′) of alkali metal that can be removed, as a function of the quantity (f′) and valency (V^{M}^{²}) of oxidizable metal, is

e′=f′(ΔV^{M}^{²}),

where ΔV^{M}^{²} is the difference between the valence state of the metal in the active material and a valence state readily available for the metal.

The O_{g} component of the compound provides the oxide and the negatively charged species in the material. Preferably 1≦g≦15, more preferably 2≦g≦13, and even more preferably 2≦g≦8.

M² may comprise a single metal, or a combination of two or more metals. In embodiments where M² is a combination of elements, the total valence of M² in the active material must be such that the resulting active material is electrically neutral.

M² may be, in general, a metal or metalloid, selected from the group consisting of elements from Group 2-14 of the Periodic Table.

In a preferred embodiment, M² comprises one or more transition metals from Groups 4 to 11. In another preferred embodiment, M² comprises a mixture of metals, wherein at least one is a transition metal from Groups 4 to 11. In another preferred embodiment, M² comprises at least one metal selected from the group consisting of Fe, Co, Ni, Cu, V, Zr, Ti, Mo and Cr, preferably 1≦f≦6.

A preferred electrode active material embodiment comprises a compound of the formula

LiNiᵣCOₛM⁶ₜO₂

wherein 0<(r+s)≦1, and 0≦t≦1. M⁶ is at least one metal selected from Group 2, 12, 13 or 14 of the Periodic Table, more preferably M⁶ is selected from the group consisting of Mg, Ca, Al, and mixtures thereof.

Alkali/transition metal oxides among those useful herein include LiMn₂O₄, LiNiO₂, LiCoO₂, LiNi_{0.75}Al_{0.25}O₂, Li₂CuO₂, γ-LiV₂O₅, LiCo_{0.5}Ni_{0.5}O₂, NaCoO₂, NaNiO₂, LiNiCoO₂, LiNi_{0.75}Co_{0.25}O₂, LiNi_{0.8}Co_{0.2}O₂, LiNi_{0.6}Co_{0.04}O₂, LiMnO₂, LiMoO₂, LiNi_{0.8}Co_{0.15}Al_{0.05}O₂, LiFeO₃, α-LiFe₅O₈, β-LiFe₅O₈, Li₂Fe₃O₄, LiFe₂O₃, LiNi_{0.6}Co_{0.2}Al_{0.2}O₂, LiNi_{0.8}Co_{0.15}Mg_{0.05}O₂, LiNi_{0.8}Co_{0.15}Ca_{0.05}O₂, NaNi_{0.8}Co_{0.15}Al_{0.05}O₂, KNi_{0.8}Co_{0.15}Mg_{0.05}O₂, LiCr_{0.8}Co_{0.15}Al_{0.05}O₂, KCoO₂, Li_{0.5}Na_{0.5}CoO₂, NaNi_{0.6}Co_{0.4}O₂, KNi_{0.75}Co_{0.25}O₂, LiFe_{0.75}Co_{0.25}O₂, LiCu_{0.8}Co_{0.2}O₂, LiTi_{0.9}Ni_{0.1}O₂, LiV_{0.8}Co_{0.2}O2, Li₃V₂Co_{0.5}Al_{0.5}O₅, Na₂LiVNi_{0.5}Mg_{0.5}O₅, Li₅CrFe_{1.5}CaO₇, LiCrO₂, LiVO₂, LiTiO₂, NaVO₂, NaTiO₂, Li₂FeV₂O₅, L₅Ni_{2.5}Co₃O₈; Li₆V₂Fe_{1.5}CaO₉, and mixtures thereof. Preferred alkali/transition metal oxides include LiNiO₂, LiCoO₂, γ-LiV₂O₅, Li₂CuO₂ and mixtures thereof.

Synthesis of Preferred Embodiments

Active materials of general formula AₐM_{b}(XY₄)_{c}Z_{d} may be readily synthesized by reacting starting materials in a solid state reaction, with or without simultaneous reduction of the metal species involved. According to the desired values of a, b, c, and d in the product, starting materials are chosen that contain “a” moles of alkali metal A from all sources, “b” moles of metals M from all sources, “c” moles of phosphate (or other XY₄ species) from all sources, and “d” moles of halide or hydroxide Z, again taking into account all sources. As discussed below, a particular starting material may be the source of more than one of the components A, M, XY₄, or Z. Alternatively it is possible to run the reaction with an excess of one or more of the starting materials. In such a case, the stoichiometry of the product will be determined by the limiting reagent among the components A, M, XY₄, and Z. Because in such a case at least some of the starting materials will be present in the reaction product mixture, it is usually desirable to provide exact molar amounts of all the starting materials. Similarly, active materials of general formula AₑM_{f}O_{g} may be synthesized by providing starting materials that provide at least “e” moles of alkali metal A from all sources and at least “f” moles of metal (or metals) M from all sources.

Sources of alkali metal include any of a number of salts or ionic compounds of lithium, sodium, potassium, rubidium or cesium. Lithium, sodium, and potassium compounds are preferred. Preferably, the alkali metal source is provided in powder or particulate form. A wide range of such materials is well known in the field of inorganic chemistry. Non-limiting examples include the lithium, sodium, and/or potassium fluorides, chlorides, bromides, iodides, nitrates, nitrites, sulfates, hydrogen sulfates, sulfites, bisulfites, carbonates, bicarbonates, borates, phosphates, hydrogen ammonium phosphates, dihydrogen ammonium phosphates, silicates, antimonates, arsenates, germanates, oxides, acetates, oxalates, and the like. Hydrates of the above compounds may also be used, as well as mixtures. In particular, the mixtures may contain more than one alkali metal so that a mixed alkali metal active material will be produced in the reaction.

Sources of metals M include salts or compounds of any of the transition metals, alkaline earth metals, or lanthanide metals, as well as of non-transition metals such as aluminum, gallium, indium, thallium, tin, lead, and bismuth. The metal compounds include, without limitation, fluorides, chlorides, bromides, iodides, nitrates, nitrites, sulfates, hydrogen sulfates, sulfites, bisulfites, carbonates, bicarbonates, borates, phosphates, hydrogen ammonium phosphates, dihydrogen ammonium phosphates, silicates, antimonates, arsenates, germanates, oxides, hydroxides, acetates, oxalates, and the like. Hydrates may also be used, as well as mixtures of metals, as with the alkali metals, so that alkali metal mixed metal active materials are produced. The metal M in the starting material may have any oxidation state, depending on the oxidation state required in the desired product and the oxidizing or reducing conditions contemplated, as discussed below. The metal sources are chosen so that at least one metal in the final reaction product is capable of being in an oxidation state higher than it is in the reaction product.

Sources of the desired starting material anions such as the phosphates, halides, and hydroxides are provided by a number of salts or compounds containing positively charged cations in addition to the source of phosphate (or other XY₄ species), halide, or hydroxide. Such cations include, without limitation, metal ions such as the alkali metals, alkaline metals, transition metals, or other non-transition metals, as well as complex cations such as ammonium or quaternary ammonium. The phosphate anion in such compounds may be phosphate, hydrogen ammonium phosphate, or dihydrogen ammonium phosphate. As with the alkali metal source and metal source discussed above, the phosphate, halide, or hydroxide starting materials are preferably provided in particulate or powder form. Hydrates of any of the above may be used, as can mixtures of the above.

A starting material may provide more than one of the components A, M, XY₄, and Z, as is evident in the list above. In various embodiments of the invention, starting materials are provided that combine, for example, the alkali metal and halide together, or the metal and the phosphate. Thus for example, lithium, sodium, or potassium fluoride may be reacted with a metal phosphate such as vanadium phosphate or chromium phosphate, or with a mixture of metal compounds such as a metal phosphate and a metal hydroxide. In one embodiment, a starting material is provided that contains alkali metal, metal, and phosphate. There is flexibility to select starting materials containing any of the components of alkali metal A, metal M, phosphate (or other XY₄ moiety), and halide/hydroxide Z, depending on availability. Combinations of starting materials providing each of the components may also be used.

In general, any anion may be combined with the alkali metal cation to provide the alkali metal source starting material, or with the metal M cation to provide the metal M starting material. Likewise, any cation may be combined with the halide or hydroxide anion to provide the source of Z component starting material, and any cation may be used as counterion to the phosphate or similar XY₄ component. It is preferred, however, to select starting materials with counterions that give rise to volatile by-products. Thus, it is desirable to choose ammonium salts, carbonates, oxides, hydroxides, and the like where possible. Starting materials with these counterions tend to form volatile by-products such as water, ammonia, and carbon dioxide, which can be readily removed from the reaction mixture.

As noted above, the active materials AₐM_{b}(XY₄)_{c}Z_{d} of the invention can contain a mixture of alkali metals A, a mixture of metals B, a mixture of components Z, and a phosphate group representative of the XY₄ group in the formula. In another aspect of the invention, the phosphate group can be completely or partially substituted by a number of other XY₄ moieties, which will also be referred to as “phosphate replacements” or “modified phosphates”. Thus, active materials are provided according to the invention wherein the XY₄ moiety is a phosphate group that is completely or partially replaced by such moieties as sulfate (SO₄)²⁻, monofluoromonophosphate, (PO₃F)²⁻, difluoromonophosphate (PO₂F)²⁻, silicate (SiO₄)⁴⁻, arsenate, antimonate, vanadates, and germanate. Analogues of the above oxygenate anions where some or all of the oxygen is replaced by sulfur are also useful in the active materials of the invention, with the exception that the sulfate group may not be completely substituted with sulfur. For example thiomonophosphates may also be used as a complete or partial replacement for phosphate in the active materials of the invention. Such thiomonophosphates include the anions (PO₃S)³⁻, (PO₂S₂)³⁻, (POS₃)³⁻, and (PS₄)³⁻. They are most conveniently available as the sodium, lithium, or potassium derivative.

To synthesize the active materials containing the modified phosphate moieties, it is usually possible to substitute all or part of the phosphate compounds discussed above with a source of the replacement anion. The replacement is considered on a stoichiometric basis and the starting materials providing the source of the replacement anions are provided along with the other starting materials as discussed above. Synthesis of the active materials containing the modified phosphate groups proceeds as discussed above, either without redox or under oxidizing or reducing conditions. As was the case with the phosphate compounds, the compound containing the modified or replacement phosphate group or groups may also be a source of other components of the active materials. For example, the alkali metal and/or the mixed metal M may be a part of the modified phosphate compound.

Non-limiting examples of sources of monofluoromonophosphates include Na₂PO₃F, K₂PO₃F, (NH₄)₂PO₃F.H₂O, LiNaPO₃F.H₂O, LiKPO₃F, LiNH₄PO₃F, NaBH₄PO₃F, NaK₃(PO₃F)₂ and CaPO₃F.2H₂O. Representative examples of sources of difluoromonophosphate compounds include, without limitation, NH₄PO₂F₂, NaPO₂F₂, KPO₂F₂, Al(PO₂F₂)₃, and Fe(PO₂F₂)₃.

When it is desired to partially or completely substitute phosphorous in the active materials with silicon, it is possible to use a wide variety of silicates and other silicon containing compounds. Thus, useful sources of silicon in the active materials of the invention include orthosilicates, pyrosilicates, cyclic silicate anions such as (Si₃O₉)⁶⁻, (Si₆O₁₈)¹²⁻ and the like and pyrocenes represented by the formula [(SiO₃)²⁻]ₙ, for example LiAl(SiO₃)₂. Silica or SiO₂ may also be used.

Representative arsenate compounds that may be used to prepare the active materials of the invention include H₃AsO₄ and salts of the anions [H₂AsO₄]⁻ and [HAsO₄]²⁻. Sources of antimonate in the active materials can be provided by antimony-containing materials such as Sb₂O₅, M¹SbO₃ where M¹ is a metal having oxidation state +1, M^{III}SbO₄ where M^{III} is a metal having an oxidation state of +3, and M^{II}Sb₂O₇ where M^{II} is a metal having an oxidation state of +2. Additional sources of antimonate include compounds such as Li₃SbO₄, NH₄H₂SbO₄, and other alkali metal and/or ammonium mixed salts of the [SbO₄]³⁻ anion.

Sources of sulfate compounds that can be used to partially or completely replace phosphorous in the active materials with sulfur include alkali metal and transition metal sulfates and bisulfates as well as mixed metal sulfates such as (NH₄)₂Fe(SO₄)₂, NH₄Fe(SO₄)₂ and the like. Finally, when it is desired to replace part or all of the phosphorous in the active materials with germanium, a germanium containing compound such as GeO₂ may be used.

To prepare the active materials containing the modified phosphate groups, it suffices to choose the stoichiometry of the starting materials based on the desired stoichiometry of the modified phosphate groups in the final product and react the starting materials together according to the procedures described above with respect to the phosphate materials. Naturally, partial or complete substitution of the phosphate group with any of the above modified or replacement phosphate groups will entail a recalculation of the stoichiometry of the required starting materials.

The sources of components A, M, and alternatively phosphate (or other XY₄ moiety) and Z along with any carbon or organic material used in the reaction may be reacted together in the solid state while exposing to electromagnetic radiation for a time and at a power and a frequency sufficient to make a reaction product. The starting materials are preferably provided in powder or particulate form. The powders are mixed together with any of a variety of procedures, such as by ball milling, blending in a mortar and pestle, and the like. Thereafter the mixture of powdered starting materials may be compressed into a tablet and/or held together with a binder material to form a closely cohering reaction mixture. However, when Z in the active material is hydroxide, it is preferable to react for a shorter amount of time so as to avoid volatilizing water instead of incorporating hydroxyl into the reaction product. Exemplart times and power settings are given in the Examples below.

The stoichiometry of the reduction can be selected along with the relative stoichiometric amounts of the starting components A, M, PO₄ (or other XY₄ moiety), and Z. It is usually easier to provide the reducing agent in stoichiometric excess and remove the excess, if desired, after the reaction. In the case of the reducing gases and the use of reducing carbon such as elemental carbon, any excess reducing agent does not present a problem. In the former case, the gas is volatile and is easily separated from the reaction mixture, while in the latter, the excess carbon in the reaction product does not harm the properties of the active material, because carbon is generally added to the active material to form an electrode material for use in the electrochemical cells and batteries of the invention. Conveniently also, the by-products carbon monoxide or carbon dioxide (in the case of carbon) or water (in the case of hydrogen) are readily removed from the reaction mixture.

The invention also includes active materials made in two or more steps wherein at least one step is carried out under reducing conditions as discussed above. Typically, in a first step, a precursor material containing a reduced metal is synthesized by one of the reductive methods. Starting materials are provided that contain at least one metal and a source of reducing carbon. The starting materials are combined to form a mixture, and the mixture is exposed to electromagnetic radiation of a frequency, at a power, and for a time sufficient to cause formation of a reaction product. In a preferred embodiment, at least one metal of the starting materials is reduced during the radiation exposure step, and the reaction product comprises a reduced metal compound. In a subsequent step, an alkali metal may be incorporated by reacting the product of the first step with an alkali metal compound, with or without reduction. In one embodiment, the starting materials of the first step contain no lithium or other alkali metal, and no lithium or other alkali metal is incorporated into the reduced metal compound. In other embodiments, the starting materials of the first step may contain lithium or other alkali metals, and the lithium or other alkali metals may be incorporated into the precursor material. However, preferably the amount of lithium or other alkali metal incorporated into the precursor material in the first step will be less than that incorporated in the subsequent step by reacting an alkali metal compound with the precursor material.

In one preferred embodiment, a metal oxide such as, for example, a transition metal oxide, may be reduced in a first step; non-limiting examples include reduction of a +6 metal to a +4 metal in the reaction exemplified by the formula

MO₃+[C]→MO₂.

Here and in the Examples, the symbol [C] is used to denote the source of reducing carbon, which can be provided by an elemental carbon, by an organic material that decomposes under the reaction conditions to form a decomposition product capable of acting as a reductant, or a combination of elemental carbon and organic material.

In the formula, M represents a +6 metal or mixture of metals having an average oxidation state of +6. M can generally be any metal capable of being reduced from +6 to +4. Non-limiting examples include V, Mo, Mn, W, Ir, Os, and Re. The following balanced equations illustrate an advantage of the reductive methods of the invention:

MO₃+½[C]→MoO₂+½CO₂

or,

MO₃+[C]→MoO₂+CO.

The only by-products are volatile CO₂ or CO. Because of this, it is usually desirable to provide the reducing carbon in stoichiometric excess. Such excess will tend to drive the reaction to completion. Excess reducing carbon remaining after reaction will be intimately mixed in the product. This is normally advantageous for subsequent use of the materials as battery active materials.

Other metal oxides can be used in the reductive methods of the invention. For example, +5 metal oxides may be reduced according to the equation

M₂O₅+[C]→M₂O₃

showing reduction from a +5 to a +3 oxidation state. Non-limiting examples of M include V and Mn. Note that here and in some of the examples below, the equations are written for clarity in unbalanced form, omitting the carbon monoxide or carbon dioxide by-products, as well as the precise stoichiometry of the reducing carbon. Such reductant stoichiometry and resulting by-products will vary, depending on the reaction conditions chosen.

To further illustrate, by way of non-limiting examples, a +4 metal oxide may be reduced to a +3 metal oxide according to

2 MO₂+[C]→M₂O₃

or to a +2 metal oxide according to the unbalanced equation,

MO₂+[C]→MO.

In another embodiment, the precursor compounds are prepared that have anions other than or in addition to the oxides described above. These preparations generally involve reacting a metal containing starting material not only with a source of reducing carbon, but also with at least a third material comprising a source of the other anions. Preferred anions include the XY₄ anions described above. Non-limiting examples of such anions include phosphate, silicate, sulfate, selenate and the like, such as described earlier. To illustrate, a transition metal phosphate may be produced by reducing a transition metal simultaneously with reaction with a material that serves as a source of phosphate. For example, transition metal phosphates may be made by reacting oxides of a transition metal with a source of phosphate as in the unbalanced equation:

M₂O₅+(NH₄)₂HPO₄+[C]→MPO₄

where M represents a metal or mixture of metals. In one embodiment, M comprises vanadium. Other non-limiting examples of a source of phosphate are phosphate salts, hydrogen phosphate salts, dihydrogen phosphate salts, and phosphoric acid (H₃PO₄). Preferably, the cations associated with the phosphate anion are those that form volatile by-products (such as ammonia or water) during the reaction. As noted above, the by-products are not given in the simplified unbalanced equation above.

The metal precursor compound may be reacted in subsequent steps with compounds containing the other groups of the active materials to form the compounds of the invention. The subsequent steps may or may not involve further reducing conditions. For example, lithium molybdenum compounds can be prepared with reduction according to the (unbalanced) equation:

Li₂CO₃+MoO₂+[C]→Li MoO₂

or without reduction according to the unbalanced equation

Li₂CO₃+MoO₂→Li₄Mo₃O₈.

In the first equation, a +4 metal (exemplified by molybdenum) is reduced to a +3 metal. In the second equation, the metal has the same oxidation state in the product as it had in the starting material. In a preferred embodiment, carbon mediated reduction is carried out in a first step. In a second step or in subsequent steps, the transition metal containing precursor compound is reacted with other starting materials to form the active materials. In a preferred embodiment, the transition metal containing precursor is reacted with an alkali metal compound, preferably a lithium compound, to prepare alkali metal containing transition metal compounds useful as battery active materials.

Other reactions that incorporate an alkali metal into a transition metal compound with or without reduction are described in co-pending applications Ser. No. 10/045,685 filed Nov. 7, 2001, Ser. No. 09/969,440 filed Oct. 2, 2001, Ser. No. 09/974,311 filed Oct. 9, 2001, and in Barker et al., PCT publication WO/01/53198, the disclosures of which are incorporated by reference. To illustrate, an alkali metal compound may be reacted with a phosphate material without reduction according to the equation:

1½Li₂CO₃+M₃(PO₄)₂+(NH₄)₃PO₄→3 LiMPO₄

where M represents a +2 metal or mixture of metals. Non-limiting examples of M include Fe, Co, and Ni.

Alternatively, a reaction may be carried out with reduction according to:

½Li₂CO₃+MPO₄+[C]→LiMPO₄

where M is a metal that is reduced from a +3 oxidation state to a +2 oxidation state. For clarity, the volatile by-products are omitted from the formula.

In another embodiment, an alkali metal and an anion such as fluoride are incorporated into a metal compound simultaneously, either without reduction according to the equation:

LiF+MPO₄→LiMPO₄F

or with reduction according to the equation:

½Li₂CO₃+LiF+MPO₄+[C]→Li₂MPO₄F.

The above reaction schemes are illustrative only. Other reactions that incorporate alkali metal into a metal compound or transition metal compound prepared by carbothermal reduction will be apparent to the skilled artisan based on the description above and the further non-limiting examples given below, as well as the disclosures incorporated by reference. The invention provides reductive methods employing a reducing carbon, or a reducing carbon in the presence of a reducing atmosphere. The reducing carbon is provided by elemental carbon, by an organic material that forms a decomposition product capable of serving as a reductant under the reaction conditions, or a combination of elemental carbon and organic material.

Before reacting the mixture of starting materials, the starting materials are intermingled. Preferably, the starting materials are in particulate form, and the intermingling results in an essentially homogeneous powder mixture of the precursors. In one aspect, the precursor powders may be dry-mixed using, for example, a ball mill. Then the mixed powders are pressed into pellets. In another aspect, the precursor powders may be mixed with a binder. The binder is selected so as to not inhibit reaction between particles of the powders. Preferred binders decompose or evaporate prior to reaching reaction conditions. Non-limiting examples include mineral oils, glycerol, and polymers that decompose or carbonize to form a carbon residue before the reaction starts, or that evaporate before the reaction starts. Many of the binders used to hold the solid particles may also function as carbon precursor compounds, as described above. In still another aspect, intermingling is accomplished by forming a wet mixture using a volatile solvent and then the intermingled particles are pressed together in pellet form to provide good grain-to-grain contact.

The mixture of starting materials is exposed to radiation of a sufficient power and frequency and for a time sufficient to form an inorganic transition metal compound reaction product. If the starting materials contain an alkali metal compound, the reaction product is an alkali metal transition metal compound. If the starting materials include a reducing agent, the reaction product is a transition metal compound having at least one transition metal in a lower oxidation state relative to its oxidation state in the starting materials.

By exposing the starting materials to electromagnetic radiation, it is believed that the materials are being “heated”. By “heating”, what is meant is that the temperature of one or more precursor starting materials is elevated. Although the invention is not limited by theory, it is believed such heating is responsible for effecting the reactions of the invention.

Under this model, the electromagnetic radiation exposure elevates the temperature of the starting materials. Applying more power will require less time to accomplish a desired temperature. The variable of time affects the extent of the electromagnetic “heating” and the temperature reached; The following general discussion of temperature is believed to have some relevance for predicting the course of reaction. The temperature of the starting materials should preferably be about 400° C. or greater, and desirably 450° C. or greater, and preferably 500° C. or greater, and generally will proceed at a faster rate at higher temperatures. The various reactions involve production of CO or CO₂ as an effluent gas. The equilibrium at higher temperature favors CO formation. Some of the reactions are more desirably conducted at temperatures greater than 600° C.; most desirably greater than 650° C.; preferably 700° C. or greater; more preferably 750° C. or greater. Suitable ranges for many reactions are about 700 to 950° C., or about 700 to 800° C.

Generally, the higher temperature reactions produce CO effluent and the stoichiometry requires more carbon be used than the case where CO₂ effluent is produced at lower temperature. This is because the reducing effect of the C to CO₂ reaction is greater than the C to CO reaction. The C to CO₂ reaction involves an increase in carbon oxidation state of +4 (from 0 to 4) and the C to CO reaction involves an increase in carbon oxidation state of +2 (from ground state zero to 2). Here, higher temperature generally refers to a range of about 650° C. to about 1000° C. and lower temperature refers to up to about 650° C. Temperatures higher than 1200° C. are not thought to be needed.

In one embodiment, the particulate starting materials are exposed to electromagnetic radiation for a time and at a power and a frequency sufficient to form a reaction product, but not reach the melting point of the starting material inorganic transition metal compound. In a preferred embodiment, at least a portion of the starting material remains in the solid state during the reaction.

In one aspect, the method of the invention utilizes the reducing capabilities of carbon in a unique and controlled manner to produce desired products having structure and alkali metal content suitable for use as electrode active materials. In one aspect the method of the invention makes it possible to produce products containing lithium, metal and oxygen in an economical and convenient process. The advantages are at least in part achieved by the reductant, carbon, having an oxide whose free energy of formation becomes more negative as the temperature (which increases with radiation intensity) increases. Such oxide of carbon is more stable at more intense radiation than at less intense radiation. This feature is used to produce products having one or more metal ions in a reduced oxidation state relative to the precursor metal ion oxidation state. The method utilizes an effective combination of quantity of carbon, time and radiation exposure to produce new products and to produce known products in a new way.

Carbothermal reduction according to the invention as described above is essentially a solid state reaction; as such the nature of the product formed in reaction depends on the particle size and the nature of particle to particle contact. Preferably, fine powders of starting materials are provided and the powdered or particulate starting materials are formed into a mixture by means of either pressure in a tableting process or in a mixture having a binder. Such mixtures are preferred in order to bring the particulate starting materials into close contact. If there is inhomogeneity in the starting materials or if the particles are not brought into contact well with one another it can lead to inhomogeneous products, lower yields, or lower quality products. The use of an atmosphere containing a reducing gas during the carbothermal reaction ensures a more uniform reaction, leading to more homogeneous products, higher yields, and higher quality products.

The present invention provides electrode active materials for use in a battery. As used herein, “battery” refers to a device comprising one or more electrochemical cells for the production of electricity. Each electrochemical cell comprises an anode, a cathode, and an electrolyte. Two or more electrochemical cells may be combined, or “stacked,” so as to create a multi-cell battery having a voltage that is the sum of the voltages of the individual cells.

The electrode active materials of this invention may be used in the anode, the cathode, or both. As used herein, the terms “cathode” and “anode” refer to the electrodes at which reduction and oxidation occur, respectively, during battery discharge. During charging of the battery, the sites of oxidation and reduction are reversed. Preferably, the active materials of this invention are used in the cathode. Also, as used herein, the words “preferred” and “preferably” refer to embodiments of the invention that afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

Electrodes:

The present invention also provides electrodes comprising an electrode active material of the present invention. In a preferred embodiment, the electrodes of the present invention comprise an electrode active material of this invention, a binder; and an electrically conductive carbonaceous material.

In a preferred embodiment, the electrodes of this invention comprise:

(a) from about 25% to about 95%, more preferably from about 50% to about 90%, active material;

(b) from about 2% to about 95% electrically conductive material (e.g., carbon black); and

(c) from about 3% to about 20% binder chosen to hold all particulate materials in contact with one another without degrading ionic conductivity.

(Unless stated otherwise, all percentages herein are by weight.) Cathodes of this invention preferably comprise from about 50% to about 90% of active material, about 5% to about 30% of the electrically conductive material, and the balance comprising binder. Anodes of this invention preferably comprise from about 50% to about 95% by weight of the electrically conductive material (e.g., a preferred graphite), with the balance comprising binder.

Electrically conductive materials among those useful herein include carbon black, graphite, powdered nickel, metal particles, conductive polymers (e.g., characterized by a conjugated network of double bonds like polypyrrole and polyacetylene), and mixtures thereof. Binders useful herein preferably comprise a polymeric material and extractable plasticizer suitable for forming a bound porous composite. Preferred binders include halogenated hydrocarbon polymers (such as poly(vinylidene chloride) and poly((dichloro-1,4-phenylene)ethylene), fluorinated urethanes, fluorinated epoxides, fluorinated acrylics, copolymers of halogenated hydrocarbon polymers, epoxides, ethylene propylene diamine termonomer (EPDM), ethylene propylene diamine termonomer (EPDM), polyvinylidene difluoride (PVDF), hexafluoropropylene (HFP), ethylene acrylic acid copolymer (EAA), ethylene vinyl acetate copolymer (EVA), EAA/EVA copolymers, PVDF/HFP copolymers, and mixtures thereof.

In a preferred process for making an electrode, the electrode active material is mixed into a slurry with a polymeric binder compound, a solvent, a plasticizer, and optionally the electroconductive material. The active material slurry is appropriately agitated, and then thinly applied to a substrate via a doctor blade. The substrate can be a removable substrate or a functional substrate, such as a current collector (for example, a metallic grid or mesh layer) attached to one side of the electrode film. In one embodiment, heat or radiation is applied to evaporate the solvent from the electrode film, leaving a solid residue. The electrode film is further consolidated, where heat and pressure are applied to the film to sinter and calendar it. In another embodiment, the film may be air-dried at moderate temperature to yield self-supporting films of copolymer composition. If the substrate is of a removable type it is removed from the electrode film, and further laminated to a current collector. With either type of substrate it may be necessary to extract the remaining plasticizer prior to incorporation into the battery cell.

Batteries:

The batteries of the present invention comprise:

(a) a first electrode comprising an active material of the present invention;

(b) a second electrode which is a counter-electrode to said first electrode; and

(c) an electrolyte between said electrodes.

The electrode active material of this invention may comprise the anode, the cathode, or both. Preferably, the electrode active material comprises the cathode.

The active material of the second, counter-electrode is any material compatible with the electrode active material of this invention. In embodiments where the electrode active material comprises the cathode, the anode may comprise any of a variety of compatible anodic materials well known in the art, including lithium, lithium alloys, such as alloys of lithium with aluminum, mercury, manganese, iron, zinc, and intercalation based anodes such as those employing carbon, tungsten oxides, and mixtures thereof. In a preferred embodiment, the anode comprises:

(a) from about 0% to about 95%, preferably from about 25% to about 95%, more preferably from about 50% to about 90%, of an insertion material;

(b) from about 2% to about 95% electrically conductive material (e.g., carbon black); and

(c) from about 3% to about 20% binder chosen to hold all particulate materials in contact with one another without degrading ionic conductivity.

In a particularly preferred embodiment, the anode comprises from about 50% to about 90% of an insertion material selected from the group active material from the group consisting of metal oxides (particularly transition metal oxides), metal chalcogenides, and mixtures thereof. In another preferred embodiment, the anode does not contain an insertion active, but the electrically conductive material comprises an insertion matrix comprising carbon, graphite, cokes, mesocarbons and mixtures thereof. One preferred anode intercalation material is carbon, such as coke or graphite, which is capable of forming the compound LiₓC. Insertion anodes among those useful herein are described in U.S. Pat. No. 5,700,298, Shi et al., issued Dec. 23, 1997; U.S. Pat. No. 5,712,059, Barker et al., issued Jan. 27, 1998; U.S. Pat. No. 5,830,602, Barker et al., issued Nov. 3, 1998; and U.S. Pat. No. 6,103,419, Saidi et al., issued Aug. 15, 2000; all of which are incorporated by reference herein.

In embodiments where the electrode active material comprises the anode, the cathode preferably comprises:

(a) from about 25% to about 95%, more preferably from about 50% to about 90%, active material;

(b) from about 2% to about 95% electrically conductive material (e.g., carbon black); and

(c) from about 3% to about 20% binder chosen to hold all particulate materials in contact with one another without degrading ionic conductivity.

Active materials useful in such cathodes include electrode active materials of this invention, as well as metal oxides (particularly transition metal oxides), metal chalcogenides, and mixtures thereof. Other active materials include lithiated transition metal oxides such as LiCoO₂, LiNiO₂, and mixed transition metal oxides such as LiCo₁₋ₘNiₘO₂, where 0<m<1. Another preferred active material includes lithiated spinel active materials exemplified by compositions having a structure of LiMn₂O₄, as well as surface treated spinels such as disclosed in U.S. Pat. No. 6,183,718, Barker et al., issued Feb. 6, 2001, incorporated by reference herein. Blends of two or more of any of the above active materials may also be used. The cathode may alternatively further comprise a basic compound to protect against electrode degradation as described in U.S. Pat. No. 5,869,207, issued Feb. 9, 1999, incorporated by reference herein.

The batteries of this invention also comprise a suitable electrolyte that provides for transfer of ions between the cathode and anode. The electrolyte is preferably a material that exhibits high ionic conductivity, as well as having insular properties to prevent self-discharging during storage. The electrolyte can be either a liquid or a solid. Solid electrolytes preferably comprise a polymeric matrix which contains an ionic conductive medium. A liquid electrolyte preferably comprises a solvent and an alkali metal salt that form an ionically conducting liquid.

One preferred embodiment is a solid polymeric electrolyte, comprising a solid polymeric matrix of an electrolyte compatible material formed by polymerizing an organic or inorganic monomer (or partial polymer thereof) and which, when used in combination with the other components of the electrolyte, results in a solid state electrolyte. Suitable solid polymeric matrices include those well known in the art and include solid matrices formed from organic polymers, inorganic polymers or a solid matrix forming monomer and from partial polymers of a solid matrix forming monomer.

The polymeric electrolyte matrix comprises a salt, typically inorganic, which is homogeneously dispersed via a solvent vehicle throughout the matrix. The solvent is preferably a low molecular weight organic solvent added to the electrolyte, which may serve the purpose of solvating the inorganic ion salt. The solvent is preferably any compatible, relatively non-volatile, aprotic, relatively polar solvent, including dimethyl carbonate (DMC), diethyl carbonate (DEC), dipropylcarbonate (DPC), ethyl methyl carbonate (EMC), butylene carbonate, gamma-butyrolactone, triglyme, tetraglyme, lactones, esters, dimethylsulfoxide, dioxolane, sulfolane, and mixtures thereof. Preferred solvents include EC/DMC, EC/DEC, EC/DPC and EC/EMC. Preferably, the inorganic ion salt is a lithium or sodium salt, such as for example, LiAsF₆, LiPF₆, LiClO₄, LiB(C₆H₅)₄, LiAlCl₄, LiBr, and mixtures thereof, with the less toxic being preferable. The salt content is preferably from about 5% to about 65%, preferably from about 8% to about 35%. A preferred embodiment is a mixture of EC:DMC:LiPF₆ in a weight ratio of about 60:30:10. Electrolyte compositions among those useful herein are described in U.S. Pat. No. 5,418,091, Gozdz et al., issued May 23, 1995; U.S. Pat. No. 5,508,130, Golovin, issued Apr. 16, 1996; U.S. Pat. No. 5,541,020, Golovin et al., issued Jul. 30, 1996; U.S. Pat. No. 5,620,810, Golovin et al., issued Apr. 15, 1997; U.S. Pat. No. 5,643,695, Barker et al., issued Jul. 1, 1997; U.S. Pat. No. 5,712,059, Barker et al., issued Jan. 27, 1997; U.S. Pat. No. 5,851,504, Barker et al., issued Dec. 22, 1998; U.S. Pat. No. 6,020,087, Gao, issued Feb. 1, 2001; and U.S. Pat. No. 6,103,419, Saidi et al., issued Aug. 15, 2000; all of which are incorporated by reference herein.

Additionally, the electrolyte comprises a separator, or is surrounded by a separator membrane. The separator allows the migration of ions through the membrane while still providing a physical separation of the electric charge between the electrodes, to prevent short-circuiting. Preferably, the separator also inhibits elevated temperatures within the battery that can occur due to uncontrolled reactions, preferably by degrading upon high temperatures to provide infinite resistance to prevent further uncontrolled reactions. In a preferred embodiment, the polymeric matrix of the electrolyte can contain an additional polymer (a separator) or the original polymeric matrix itself may function as a separator, providing the physical isolation needed between the anode and cathode.

A preferred electrolyte separator film comprises approximately two parts polymer for every one part of a preferred fumed silica. The conductive solvent comprises any number of suitable solvents and salts. Desirable solvents and salts are described in U.S. Pat. No. 5,643,695, Barker et al., issued Jul. 1, 1997; and U.S. Pat. No. 5,418,091, Gozdz et al., issued May 23, 1995; both of which are incorporated by reference herein. One example is a mixture of EC:DMC:LiPF₆ in a weight ratio of about 60:30:10.

A separator membrane element is generally polymeric and prepared from a composition comprising a copolymer. A preferred composition is the 75 to 92% vinylidene fluoride with 8 to 25% hexafluoropropylene copolymer (available commercially from Atochem North America as Kynar FLEX) and an organic solvent plasticizer. Such a copolymer composition is also preferred for the preparation of the electrode membrane elements, since subsequent laminate interface compatibility is ensured. The plasticizing solvent may be one of the various organic compounds commonly used as solvents for electrolyte salts, e.g., propylene carbonate or ethylene carbonate, as well as mixtures of these compounds. Higher-boiling plasticizer compounds such as dibutyl phthalate, dimethyl phthalate, diethyl phthalate, and tris butoxyethyl phosphate are preferred. Inorganic filler adjuncts, such as fumed alumina or silanized fumed silica, may be used to enhance the physical strength and melt viscosity of a separator membrane and, in some compositions, to increase the subsequent level of electrolyte solution absorption.

A preferred battery comprises a laminated cell structure, comprising an anode layer, a cathode layer, and electrolyte/separator between the anode and cathode layers. The anode and cathode layers comprise a current collector. A preferred current collector is a copper collector foil, preferably in the form of an open mesh grid. The current collector is connected to an external current collector tab, for a description of tabs and collectors. Such structures are disclosed in, for example, U.S. Pat. No. 4,925,752, Fauteux et al, issued May 15, 1990; U.S. Pat. No. 5,011,501, Shackle et al., issued Apr. 30, 1991; and U.S. Pat. No. 5,326,653, Chang, issued Jul. 5, 1994; all of which are incorporated by reference herein. In a battery embodiment comprising multiple electrochemical cells, the anode tabs are preferably welded together and connected to a nickel lead. The cathode tabs are similarly welded and connected to a welded lead, whereby each lead forms the polarized access points for the external load.

Lamination of assembled cell structures is accomplished by conventional means by pressing between metal plates at a temperature of about 120-160° C. Subsequent to lamination, the battery cell material may be stored either with the retained plasticizer or as a dry sheet after extraction of the plasticizer with a selective low-boiling point solvent. The plasticizer extraction solvent is not critical, and methanol or ether are often used.

In a preferred embodiment, a electrode membrane comprising the electrode active material (e.g., an insertion material such as carbon or graphite or a insertion compound) dispersed in a polymeric binder matrix. The electrolyte/separator film membrane is preferably a plasticized copolymer, comprising a polymeric separator and a suitable electrolyte for ion transport. The electrolyte/separator is positioned upon the electrode element and is covered with a positive electrode membrane comprising a composition of a finely divided lithium insertion compound in a polymeric binder matrix. An aluminum collector foil or grid completes the assembly. A protective bagging material covers the cell and prevents infiltration of air and moisture.

In another embodiment, a multi-cell battery configuration may be prepared with copper current collector, a negative electrode, an electrolyte/separator, a positive electrode, and an aluminum current collector. Tabs of the current collector elements form respective terminals for the battery structure.

In a preferred embodiment of a lithium-ion battery, a current collector layer of aluminum foil or grid is overlaid with a positive electrode film, or membrane, separately prepared as a coated layer of a dispersion of insertion electrode composition. This is preferably an insertion compound such as the active material of the present invention in powder form in a copolymer matrix solution, which is dried to form the positive electrode. An electrolyte/separator membrane is formed as a dried coating of a composition comprising a solution containing VdF:HFP copolymer and a plasticizer solvent is then overlaid on the positive electrode film. A negative electrode membrane formed as a dried coating of a powdered carbon or other negative electrode material dispersion in a VdF:HFP copolymer matrix solution is similarly overlaid on the separator membrane layer. A copper current collector foil or grid is laid upon the negative electrode layer to complete the cell assembly. Therefore, the VdF:HFP copolymer composition is used as a binder in all of the major cell components, positive electrode film, negative electrode film, and electrolyte/separator membrane. The assembled components are then heated under pressure to achieve heat-fusion bonding between the plasticized copolymer matrix electrode and electrolyte components, and to the collector grids, to thereby form an effective laminate of cell elements. This produces an essentially unitary and flexible battery cell structure.

Cells comprising electrodes, electrolytes and other materials among those useful herein are described in the following documents, all of which are incorporated by reference herein: U.S. Pat. No. 4,668,595, Yoshino et al., issued May 26, 1987; U.S. Pat. No. 4,792,504, Schwab et al., issued Dec. 20, 1988; U.S. Pat. No. 4,830,939, Lee et al., issued May 16, 1989; U.S. Pat. No. 4,935,317, Fauteaux et al., issued Jun. 19, 1980; U.S. Pat. No. 4,990,413, Lee et al., issued Feb. 5, 1991; U.S. Pat. No. 5,037,712, Shackle et al., issued Aug. 6, 1991; U.S. Pat. No. 5,262,253, Golovin, issued Nov. 16, 1993; U.S. Pat. No. 5,300,373, Shackle, issued Apr. 5, 1994; U.S. Pat. No. 5,399,447, Chaloner-Gill, et al., issued Mar. 21, 1995; U.S. Pat. No. 5,411,820, Chaloner-Gill, issued May 2, 1995; U.S. Pat. No. 5,435,054, Tonder et al., issued Jul. 25, 1995; U.S. Pat. No. 5,463,179, Chaloner-Gill et al., issued Oct. 31, 1995; U.S. Pat. No. 5,482,795, Chaloner-Gill., issued Jan. 9, 1996; U.S. Pat. No. 5,660,948, Barker, issued Sep. 16, 1995; and U.S. Pat. No. 6,306,215, Larkin, issued Oct. 23, 2001. A preferred electrolyte matrix comprises organic polymers, including VdF:HFP. Examples of casting, lamination and formation of cells using VdF:HFP are as described in U.S. Pat. No. 5,418,091, Gozdz et al., issued May 23, 1995; U.S. Pat. No. 5,460,904, Gozdz et al., issued Oct. 24, 1995; U.S. Pat. No. 5,456,000, Gozdz et al., issued Oct. 10, 1995; and U.S. Pat. No. 5,540,741, Gozdz et al., issued Jul. 30, 1996; all of which are incorporated by reference herein.

The electrochemical cell architecture is typically governed by the electrolyte phase. A liquid electrolyte battery generally has a cylindrical shape, with a thick protective cover to prevent leakage of the internal liquid. Liquid electrolyte batteries tend to be bulkier relative to solid electrolyte batteries due to the liquid phase and extensive sealed cover. A solid electrolyte battery, is capable of miniaturization, and can be shaped into a thin film. This capability allows for a much greater flexibility when shaping the battery and configuring the receiving apparatus. The solid state polymer electrolyte cells can form flat sheets or prismatic (rectangular) packages, which can be modified to fit into the existing void spaces remaining in electronic devices during the design phase.

Aspects of the invention have been described above with respect to preferred embodiments. Further non-limiting description of the invention is provided in the examples that follow.

### EXAMPLE 1

The active material γ-LiV₂O₅ is produced according to the following general reaction scheme.

V₂O₅+0.5 Li₂CO₃+0.25 C→LiV₂O₅+0.75 CO₂

1.82 g V₂O₅ (Alfa Aesar), 0.379 g Li₂CO₃ (Pacific Lithium Company), and 0.038 g Shawinighan black (Chevron, 25% excess) are pre-mixed and pelletized. The pellet is mounted onto a ceramic disc, sealed inside an argon-filled glass chamber using a Parafilm® covering, and placed in a Panasonic Model NN-L939 microwave oven. This oven operates at a microwave frequency of 2.45 GHz with a maximum output power of 1.2 kW. The pellet is exposed for 3 minutes at the 40% power setting, followed by exposure for an additional 2 minutes at 60% power. Gas is released during the course of the reaction. Colored flashes of light are also observed originating from the sample. Following irradiation, the sample is cooled to room temperature, and powderized. The product is black and appears uniform. X-ray diffraction shows the peaks expected for LiV₂O₅. Electrochemical testing indicates good reversibility for a cell including the active material.

In the above Example, the reaction is carried out at less than approximately 650° C., therefore, the equilibrium favors formation of CO₂ rather then CO. If the reaction is carried out at temperatures above approximately 650° C., then the equilibrium favors formation of CO and the reaction may be written as:

V₂O₅+0.5 Li₂CO₃+0.5 C→LiV₂O₅+1.50 CO

If this is the case, then proportionally more carbon is needed to complete the reaction. Also in the above Example, Suitable lithium sources other than Li2CO3 may also be used, such as LiOH, LiOH.H2O, Li2O etc.

### EXAMPLE 2

The active material LiFe_{0.9}Mg_{0.1}PO₄ is made according to the following general reaction scheme.

1.00 LiH₂PO₄+0.45 Fe₂O₃+0.10 Mg(OH)₂+0.45 C→LiFe_{0.9}Mg_{0.1}PO₄+0.45 CO+H₂O

6.234 g LiH₂PO₄ (Aldrich), 4.314 g Fe₂O₃ (Alfa Aesar), 0.303 g Mg(OH)₂ (Alfa Aesar), and 0.648 g Shawinighan black (Chevron, 100% excess) are pre-mixed and pelletized. The pellet is mounted onto a ceramic disc, sealed inside an argon-filled glass chamber using a Parafilm® covering, and placed in a Panasonic Model NN-L939 microwave oven. This oven operates at a microwave frequency of 2.45 GHz with a maximum output power of 1.2 kW. The pellet is exposed for 2 minutes at the 70% power setting, followed by a second exposure for an additional 2 minutes at the same power, for a total of 4 minutes. Gas is released during the course of the reaction. Colored flashes of light are also observed originating from the sample. Following irradiation, the sample is cooled to room temperature, and powderized. The powder is then re-pelletized, and the irradiation, cooling, and powderization steps are repeated. The products appears black in color. X-ray diffraction shows the peaks expected for LiFe_{0.9}Mg_{0.1}PO₄. Electrochemical testing indicates a reversible specific capacity of 88 mAh/g.

### EXAMPLE 3

The precursor material MoO₂ is made by the following general reaction scheme. MoO₂ is a precursor material useful for the preparation of the cathode active compounds LiMoO₂ and Li₄Mo₃O₈.

1.0 MoO₃+1.0 C→MoO₂+1.0 CO

3.084 g MoO₃ (Aldrich) and 0.32 g Shawinighan black (Chevron, 25% excess) are pre-mixed and pelletized. The pellet is mounted onto a ceramic disc, sealed inside an argon-filled glass chamber using a Parafilm® covering, and placed in a Panasonic Model NN-L939 microwave oven. This oven operates at a microwave frequency of 2.45 GHz with a maximum output power of 1.2 kW. The pellet is exposed for 1 minute at the 50% power setting, followed by an additional 2 minutes at 70%, for a total of 3 minutes. Gas is released during the course of the reaction. Colored flashes of light are also observed originating from the sample. Following irradiation, the sample is cooled to room temperature, and powderized. The powder is then re-pelletized, and the irradiation, cooling, and powderization steps are repeated. The product appears dark black to brown and has good uniformity.

### EXAMPLE 4

The precursor material Fe₃(PO₄)₂ is made according to the following general reaction scheme. Fe₃(PO4)₂ is a precursor material useful for the preparation of the cathode active compound LiFe_{0.9}Mg_{0.1}PO₄.

2.00 FePO₄+0.50 Fe₂O₃+1.50 C →Fe₃(PO₄)₂+1.50 C

3.00 g FePO₄ (Strem Chemical Company), 0.790 Fe₂O₃ (Alfa Aesar), and 0.360 g Shawinighan black (Chevron, 100% excess) are pre-mixed and pelletized. The pellet is mounted onto a ceramic disc, sealed inside an argon-filled glass chamber using a Parafilm® covering, and placed in a Panasonic Model NN-L939 microwave oven. This oven operates at a microwave frequency of 2.45 GHz with a maximum output power of 1.2 kW. The pellet is exposed for 3 minutes at the 100% power setting. Gas is released during the course of the reaction. Colored flashes of light are also observed originating from the sample. Following irradiation, the sample is cooled to room temperature and powderized. The product is black and uniform.

### EXAMPLE 5

An electrode active material of the formula Li_{1.025} Co_{0.8} Fe_{0.1}Al_{0.025}Mg_{0.05}PO₄ (Li Co_{0.8} Fe_{0.1} Al_{0.025} Mg_{0.05} Li_{0.025}PO₄) is made as follows. The following sources of Li, Co, Fe, Al, and phosphate are provided containing the respective elements in a molar ratio of 1.025:0.8:0.1:0.025:0.05:1.

| | |
|---|---|
| 0.05125 moles Li₂CO₃ (mol. wt. 73.88 g/mol) | 3.8 g |
| 0.02667 moles Co₃ O₄ (240.8 g/mol) | 6.42 g |
| 0.005 moles Fe₂ O₃ (159.7 g/mol) | 0.8 g |
| 0.0025 moles Al (OH)₃ (78 g/mol) | 0.195 g |
| 0.005 moles Mg(OH)₂ (58 g/mol) | 0.29 g |
| 0.1 moles (NH₄)₂HPO₄ (132 g/mol) | 13.2 g |
| 0.2 moles elemental carbon (12 g/mol) (>100% excess) | 2.4 g |

The above starting materials are combined and ball milled to mix the particles. Thereafter, the particle mixture is pelletized. The pelletized mixture is exposed to microwave radiation at a frequency and power and for a time sufficient to form a reaction product. An x-ray diffraction pattern shows that the material has an olivine type crystal structure. An electrode is made with 80% of the active material, 10% of Super P conductive carbon, and 10% poly vinylidene difluoride. A cell with that electrode as cathode and a carbon intercalation anode is constructed with an electrolyte comprising 1 M LiPF₆ dissolved in a 3:1 by weight mixture of γ-butyrolactone:ethylene carbonate.

### EXAMPLE 6

The active material Li₃V₂(PO₄)₃ is made according to the following general reaction scheme.

V₂O₅+½Li₂CO₃+3(NH₄)HPO₄+C→Li₃V₂(PO₄)₃+CO+1.5 CO₂+6 NH₃+4.5 H₂O

Starting materials are combined in the molar proportions given in the equation, except that C is present in 100% mass excess. The materials are pelletized, and exposed to microwave radiation for a time sufficient to form a reaction product.

The examples and other embodiments described herein are exemplary and not intended to be limiting in describing the full scope of compositions and methods of this invention. Equivalent changes, modifications and variations of specific embodiments, materials, compositions and methods may be made within the scope of the present invention, with substantially similar results.

What is claimed is:

1. A solid state method for synthesizing a reduced metal compound, comprising the steps of:
combining starting materials comprising at least one particulate metal compound and at least one source of reducing carbon to form a mixture; and
exposing the mixture to an electromagnetic radiation to form a reaction product comprising the reduced metal compound,
wherein at least one metal of the starting materials is reduced in oxidation state during radiation exposure.

2. A method according to claim 1, wherein the electromagnetic radiation has a frequency of 1 MHz to 3000 GHz.

3. A method according to claim 1, wherein the electromagnetic radiation has a frequency of 1 MHz to 100 MHz.

4. A method according to claim 1, wherein the electromagnetic radiation has a frequency of 500 MHz to 1000 GHz.

5. A method according to claim 1, wherein the electromagnetic radiation has a frequency of 500 MHz to 100 GHz.

6. A method according to claim 1, wherein the electromagnetic radiation has a frequency of 500 MHz to 10 GHz.

7. A method according to claim 1, wherein the electromagnetic radiation has a frequency of 800 MHz to 3 GHz.

8. A method according to claim 1, wherein the exposure to electromagnetic radiation is conducted for a time and at a power level sufficient to release gas comprising at least one of carbon monoxide and carbon dioxide.

9. A method according to claim 1, wherein the source of reducing carbon comprises at least one selected from the group consisting of elemental carbon, organic material, carbohydrate, and sucrose.

10. A method according to claim 9, wherein the organic material decomposes to form a decomposition product containing a greater atomic proportion of carbon as compared to said organic material.

11. A method according to claim 10, wherein said decomposition product is capable of acting as a reductant during the radiation exposure.

12. A method according to claim 1, wherein the at least one particulate metal compound comprises a compound of a metal selected from the group consisting of titanium, vanadium, chromium, manganese, iron, cobalt, nickel, copper, molybdenum, tin, and mixtures thereof.

13. A method according to claim 1, wherein the starting materials further comprise an alkali metal compound.

14. A method according to claim 13, wherein the alkali metal compound comprises a lithium compound.

15. A method according to claim 1, wherein the starting materials contain no alkali metal.

16. A method according to claim 1, further comprising the step of reacting an alkali metal compound with the reaction product.

17. A method according to claim 16, wherein the step of reacting an alkali metal compound with the reaction product is carried out with no reduction.

18. A method according to claim 16, wherein the alkali metal compound comprises a lithium compound.

19. A method according to claim 1, wherein the reaction is carried out in an atmosphere comprising a reducing gas.

20. A method according to claim 19, wherein the reducing gas comprises hydrogen.

21. A method according to claim 19, wherein the reducing gas comprises CO.

22. A method according to claim 1, wherein the reaction product comprises at least one selected from the group consisting of transition metal oxide and transition metal phosphate.

23. An active material comprising a reaction product of an alkali metal compound with a transition metal compound, wherein the transition metal compound is made by a process according to claim 1.

24. A solid state method for synthesizing a metal compound product, comprising the steps of:
combining starting materials comprising at least one particulate metal compound and at least one source of carbon to form a mixture; and
exposing the mixture to electromagnetic radiation to form the metal compound product.

25. A method according to claim 24, wherein the electromagnetic radiation has a frequency of 1 MHz to 3000 GHz.

26. A method according to claim 24, wherein the electromagnetic radiation has a frequency of 1 MHz to 100 MHz.

27. A method according to claim 24, wherein the electromagnetic radiation has a frequency of 500 MHz to 1000 GHz.

28. A method according to claim 24, wherein the electromagnetic radiation has a frequency of 500 MHz to 100 GHz.

29. A method according to claim 24, wherein the electromagnetic radiation has a frequency of 500 MHz to 10 GHz.

30. A method according to claim 24, wherein the electromagnetic radiation has a frequency of 800 MHz to 3 GHz.

31. A method according to claim 24, wherein the source of carbon comprises at least one selected from the group consisting of, elemental carbon, organic material, carbohydrate and sucrose.

32. A method according to claim 31, wherein the organic material decomposes to form a decomposition product containing a greater atomic proportion of carbon as compared to said organic material.

33. A method according to claim 32, wherein said decomposition product is capable of acting as a reductant during the radiation exposure.

34. A method according to claim 24, wherein the at least one particulate metal compound comprises a compound of a metal selected from the group consisting of titanium, vanadium, chromium, manganese, iron, cobalt, nickel, copper, molybdenum, tin, and mixtures thereof.

35. A method according to claim 24, wherein the starting materials contain no alkali metal.

36. A method according to claim 35, further comprising the step of reacting an alkali metal compound with the reaction product.

37. A method according to claim 36, wherein the step of reacting an alkali metal compound with the reaction product is carried out with no reduction.

38. A method according to claim 36, wherein the alkali metal compound comprises a lithium compound.

39. A method according to claim 24, wherein the reaction is carried out in an atmosphere comprising a reducing gas.

40. A method according to claim 24, wherein the reaction product comprises at least one selected from the group consisting of transition metal oxide and transition metal phosphate.

41. An active material comprising a reaction product of an alkali metal compound with a transition metal compound, wherein the transition metal compound is made by a process according to claim 24.

42. A method for synthesizing an alkali metal compound product comprising:
a) in a first stage, preparing a metal precursor compound by a process comprising the steps of:
combining starting materials comprising at least one metal compound and at least one source of carbon to provide a mixture;
exposing the mixture to electromagnetic radiation sufficient to form a reaction product comprising the metal precursor compound, and
b) in a subsequent stage, reacting a source of alkali metal with the metal precursor compound to form the alkali metal compound product.

43. A method according to claim 42, wherein the metal precursor compound comprises at least one selected from the group consisting of transition metal oxide and transition metal phosphate.

44. A method according to claim 42, wherein the alkali metal source is a lithium compound.

45. A method according to claim 42, wherein the first stage is carried out by reducing the oxidation state of at least a portion of the metal in the at least one metal compound.

46. A method according to claim 42 wherein the exposure to electromagnetic radiation is conducted for a time and at a power level sufficient to release gas comprising at least one of carbon monoxide and carbon dioxide.

47. A method according to claim 42, wherein the electromagnetic radiation has a frequency of 1 MHz to 3000 GHz.

48. A method according to claim 42, wherein the electromagnetic radiation has a frequency of 1 MHz to 100 MHz.

49. A method according to claim 42, wherein the electromagnetic radiation has a frequency from about 500 MHz to about 1000 GHz.

50. A method according to claim 42 wherein said electromagnetic radiation has a frequency from about 800 MHz to about 10 GHz.

51. A method according to claim 42, wherein the source of reducing carbon comprises at least one selected from the group consisting of elemental carbon, organic material, carbohydrate, and sucrose.

52. A method according to claim 51, wherein the organic material decomposes to form a decomposition product containing a greater atomic proportion of carbon as compared to said organic material.

53. A method according to claim 52, wherein said decomposition product is capable of reacting during the radiation exposure.

54. A method according to claim 42, wherein the reaction is carried out in an atmosphere comprising a reducing gas.

55. A method according to claim 42, wherein the subsequent stage is carried out in the presence of a source of carbon.

56. A method according to claim 55, wherein the subsequent stage comprises the steps of:
combining the metal precursor compound, the source of alkali metal, and the source of carbon to form a reaction mixture; and
exposing the reaction mixture to electromagnetic radiation to form the alkali metal compound product.

57. A method according to claim 42, wherein the alkali metal compound product comprises at least one selected from the group consisting of a lithium transition metal oxide, lithiated molybdenum oxide, lithium transition metal titanate, lithium vanadium oxide, lithium metal phosphate.

58. A method according to claim 42, wherein the alkali metal compound product comprises a compound of general formula
AₐM_{b}(XY₄)_{c}Z_{d},
wherein
(a) A is selected from the group consisting of Li, Na, K, and mixtures thereof, and 0<a≦8;
(b) M is one or more metals, comprising at least one metal which is capable of undergoing oxidation to a higher valence state, and 1≦b≦3;
(c) XY₄ is selected from the group consisting of X′O₄₋ₓY′ₓ, X′O_{4-y}Y′_{2y}, X″S₄, and mixtures thereof, where X′ is selected from the group consisting of P, As, Sb, Si, Ge, V, S, and mixtures thereof; X″ is selected from the group consisting of P, As, Sb, Si, V, Ge and mixtures thereof; Y′ is selected from the group consisting of halogen, S, or N; 0≦x≦3; and 0≦y≦2; and 0≦c≦3; and
(d) Z is OH, halogen, or mixtures thereof, and 0≦d≦6.

59. A method according to claim 58, wherein M comprises a mixture of metals, M′ₑM″_{f}, where M′ is at least one transition metal from Groups 4 to 11, M″ is at least one element which is from Groups 2, 3, 12, 13, or 14; e+f=b; 0.8≦a≦1.2; and 0.8≦b≦1.2

60. A method according to claim 58, wherein M″ is selected from the group consisting of Mg, Ca, Zn, Ba, Al, and mixtures thereof.

61. A method according to claim 58, wherein XY₄ comprises PO₄.

62. A method according to claim 42, wherein the alkali metal compound product comprises a compound of general formula
LiₐCoₑFe_{f}M¹_{g}M²ₕM³ᵢXY₄
wherein
(a) 0<a≦2, e>0, and f>0;
(b) M¹ comprises one or more transition metals, where g≧0;
(c) M² comprises one or more +2 oxidation state non-transition metals, where h≧0;
(d) M³ comprises one or more +3 oxidation state non-transition metals, where i≧0; and
(e) XY₄ is selected from the group consisting of X′O₄₋ₓY′ₓ, X′O_{4-y}Y′_{2y}, X″S₄, and mixtures thereof, where X′ is selected from the group consisting of P, As, Sb, Si, Ge, V, S, and mixtures thereof; X″ is selected from the group consisting of P, As, Sb, Si, Ge, V, and mixtures thereof; Y′ is selected from the group consisting of halogen, N, and mixtures thereof; 0≦x≦3; and 0≦y≦2; and
wherein (e+f+g+h+i)≦2, and M¹, M², M³, XY₄,a, e, f, g, h, i, x, and y are selected so as to maintain electroneutrality of said compound.

63. A method according to claim 62, wherein 0.9≦(e+f+g+h+i)≦1; e≧0.8; 0.05≦f≦0.15; 0.05≦g≦0.2; 0.02≦(h+i)≦0.3; and 0.01≦h≦0.1.

64. A method according to claim 63, wherein M¹ is selected from the group consisting of Ti, V, Cr, Mn, Ni, Cu and mixtures thereof.

65. A method according to claim 63, wherein M² is selected from the group consisting of Be, Mg, Ca, Sr, Ba, and mixtures thereof.

66. A method according to claim 65, wherein M² is Mg.

67. A method according to claim 63, wherein M³ is selected from the group consisting of B, Al, Ga, In and mixtures thereof.

68. A method according to claim 67, wherein M³ is Al.

69. An electrode comprising an active material made according to the method of claim 42.

70. An electrode comprising an active material made according to the method of claim 58.

71. An electrode comprising an active material made according to the method of claim 62.

72. A method for synthesizing an alkali metal compound product comprising:
a) in a first stage, preparing a metal precursor compound by a process comprising the steps of:
combining starting materials comprising at least one metal compound and at least one source of carbon to provide a mixture;
exposing the mixture to electromagnetic radiation to form a reaction product comprising the metal precursor compound, wherein at least one metal is reduced in oxidation state during exposure to the electromagnetic radiation; and
b) in a subsequent stage, reacting a source of alkali metal with the metal precursor compound to form the alkali metal compound product.

73. A method of preparing a finely dispersed mixture of electrochemically active material and a conductive carbon, comprising the steps of:
preparing a mixture comprising at least one alkali metal compound, at least one metal compound, and a carbon-containing composition selected from the group consisting of elemental carbon and an organic material; and
exposing the mixture to electromagnetic radiation to form a reaction product.

74. A method according to claim 73, wherein the electromagnetic radiation has a frequency of 1 MHz to 3000 GHz.

75. A method according to claim 73, wherein the electromagnetic radiation has a frequency of 1 MHz to 100 MHz.

76. A method according to claim 73, wherein the electromagnetic radiation has a frequency of 500 MHz to 1000 GHz.

77. A method according to claim 73, wherein the electromagnetic radiation has a frequency of 500 MHz to 100 GHz.

78. A method according to claim 73, wherein the electromagnetic radiation has a frequency of 500 MHz to 10 GHz.

79. A method according to claim 73, wherein the electromagnetic radiation has a frequency of 800 MHz to 3 GHz.

80. A method according to claim 73, wherein the exposure to electromagnetic radiation is conducted for a time and at a power level sufficient to release gas comprising at least one of carbon monoxide and carbon dioxide.

81. A method according to claim 73, wherein said electromagnetic radiation has a frequency from about 500 MHz to about 1000 GHz.

82. A method according to claim 73, wherein at least one metal is reduced in oxidation state during exposure to electromagnetic radiation.

83. A method according to claim 73, wherein the reaction proceeds without reduction.

84. A method according to claim 73, wherein the reaction takes places in a reducing atmosphere.

85. A method according to claim 73, wherein the carbon-containing composition comprises elemental carbon in powdered form.

86. A method according to claim 73, wherein the carbon-containing composition is selected from the group consisting of Shawinighan black, graphite, carbon black, and amorphous carbon.

87. A method according to claim 73, wherein the finely dispersed mixture comprises crystals of active material nucleated onto grains of carbon.
